(19) United States
(12) Patent Application Publication
(10) Pub. No.: US 2004/0005159 A1
(43) Pub. Date: Jan. 8, 2004

(54) Image forming apparatus

(76) Inventors: Mitsuhiro Ito, Shizuoka (JP); Hiroaki Sakai, Shizuoka (JP)

Correspondence Address: FITZPATRICK CELLA HARPER & SCINTO, 30 ROCKEFELLER PLAZA, NEW YORK, NY, 10112, US

(21) Appl. No.: 10/609,469

(22) Filed: Jul. 1, 2003

(30) Foreign Application Priority Data
Jul. 5, 2002 (JP) 2002-197743
Jul. 12, 2002 (JP) 2002-204877

(51) Int. Cl. G03G 15/02

(52) U.S. Cl. 399/50

(57) ABSTRACT

This invention provides an image forming apparatus where the useful life of the image carrier does not become significantly short. This system has a charging unit, a charge voltage loading unit, an exposure unit, a development unit, an image transfer unit and a control unit, wherein, when the transport interval of the plural recording materials is shorter than a predetermined time the AC charge voltage applied to the image carrier during the transport interval being a first AC charge voltage, and when the transport interval is longer than the predetermined time the ac charge voltage applied to the image carrier during the transport interval being a second AC charge voltage, the control unit makes the current running in the charging unit to which the second charge voltage is applied lower than the current running in the charging unit to which the first AC charge voltage is applied.

This application claims priority from Japanese Patent Application Nos. 2002-197743 filed Jul. 5, 2002 and 2002-204877 filed Jul. 12, 2002, which are incorporated hereinto by reference.

### BACKGROUND OF THE INVENTION

1. Field of the Invention

The present invention relates to an electrophotographic image forming apparatus. More particularly, the invention relates to an image forming apparatus for forming images by the electrophotographic process using copiers and printers.

2. Description of the Related Art

Many of the electrographic copiers and printers form images on one side of a recording material such as recording paper. Now, however, what is called the double-sided image forming apparatus, which is capable of forming images on both sides of a sheet for environmental protection and savings of natural resources, has been commercialized. The double-sided image forming apparatus prints images on a first side and then on the other side, utilizing a paper turnover mechanism that turns over the sheet of which one side has been printed and a re-feeder mechanism that feeds the sheet again.

FIG. 1 is a diagram illustrating an example of the structure of the prior art electro-photographic laser beam printer. This laser beam printer has a sheet turn-over unit and a re-feeder unit near the center of the printer itself 100, and has a detachable transfer unit D for double-sided printing in the body. A paper cassette 101 that houses sheets of paper P is located at the bottom of the body. Sheet P is transported by a transport roller 108 to a process cartridge 112 via a pickup roller 104, a feeder roller 105 and a retard roller 106 that feed paper, separating sheets P one by one. In the upstream of the process cartridge 112 installed are a pre-resist sensor 110 that detects sheet P and resist rollers 109 that transport sheet P synchronously.

The process cartridge 112 is detachably attached to the body and forms an electrostatic latent image with laser light from the scanner 111 on the photosensitive drum 1 working as the image carrier. Then a visible image or toner image is produced by developing this latent image. The scanner 111 is generally composed of a laser unit 129 that emits laser light, a polygon mirror 130 than scans the laser light form he laser unit 129 on the photosensitive drum 1, a polygon motor 131, an image formation lens assembly 132 and a return mirror 133. The process cartridge 112 is equipped with a photosensitive drum 1, a charger 2, a developer 134 and a cleaner 6 that are all needed in the common electro-photography.

Conventionally, the charger 2 is usually a non-contact type corona charger that charges the photosensitive drum surface by providing corona produced by high-voltage applied to a thin corona discharge wire. In recent years, however, the contact type charger has been most preferably used because of its advantages of lower pressure process, less ozone emission and lower cost. This is a method of, for example, contacting a roller charger material (hereinafter, roller charger) to the surface of the photosensitive drum 1 and charges the photosensitive drum 1 by applying voltage to this roller charger 2. Although voltage applied to the roller charger 2 may be DC voltage alone, charging becomes uniform if AC voltage is additionally applied to repeat plus/minus discharge alternatively. By exposing the uniformly charged photosensitive drum 1 to laser light using the scanner 111, the desired latent image is formed thereon and this latent image is transformed into a toner image by the developer 134.

A development bias is applied to the development roller constituting the developer 134. As the bias voltage for development, only DC voltage is applied when the development roller 134 contacts the photosensitive drum 1, while AC voltage is added to DC voltage during non-contact operation. The toner image on the photosensitive drum 1 is transferred to sheet P by the transfer roller 113.

In the downstream of the process cartridge 112 installed is a fixer F that affixes the toner image transferred to sheet P by applying heat and pressure thereto. Fixer F is generally composed of a fixer roller 117, a heater 116 that heats the fixer roller 117, a pressure roller 118 and a temperature sensor 140 such as a thermistor. The pressure roller 118 is pressed onto the fixer roller 117 by a spring unit (not shown). In the downstream of this fixer F installed are fixer exit rollers 139 and a fixer unit sensor 119 that detects the passage of sheet P.

In the downstream of the fixer exit rollers 139, the transport path is branched and the flapper 120 decides the way of paper transport. In usual single-sided printing, sheet P is conveyed to the outside of the body by the output rollers 122, while for double-sided printing it is sent to the transport unit in the turn-over unit.

The transport unit for double-sided printing has a sheet turn-over unit equipped with reverse rollers 123 and a reverse sensor 124, and a re-feeder unit equipped with a D-cut roller 125, a sensor 126 and transport rollers 127 in turn-over unit D.

The transport path is branched in the upstream of the reverse rollers 123, and a reverse sensor 124 is installed near the branching point. Sheet P is stopped in the position where the end of sheet P has traveled a prescribed distance passing the reverse sensor 124, and then sent to the re-feeder unit by reverse rotation of the reverse rollers 123.

When the turn-over unit sensor 126 has detected the passage of sheet P, the transport rollers 127 in the downstream in the turn-over unit convey sheet P to the transport roller 108 again for re-feeding. Later, sheet P passes the resist rollers 109 again, and the transfer roller 113 conducts image formation on the other side of sheet P. Then sheet P is guided by the flapper 120 to the output rollers 122 for output after toner is fixed by fixer F.

In this type image forming apparatus, the number of sheets waiting in the transport path in the sheet turn-over mechanism and re-feeder mechanism is determined according to sheet sizes, and their printing sequence is optimized for efficient double-sided printing (for example, Japanese Patent Application Laid-open No. 2002-091102). If a large number of sheets are to be printed double-sided, their printing sequence is changed so that the number of sheets waiting in the transport path in the sheet turn-over mechanism and re-feeder mechanism is maximized according to sheet sizes. Such changes of printing sequence are conducted by altering the page sequence based on their printing information that is sent form PC, for example, and stored in the memory of the printer.

However, when the memory capacity in the printer is small, it cannot hold the printing information of many pages and thus the printing sequence cannot be changed. When the memory capacity is small, the sheet is turned over after its first side is printed and then re-fed for printing on the other side (rear face). Each of the two or more sheets is printed in this manner. Then instead of plural sheets, only one sheet is held in the transport path of the sheet turn-over mechanism and the re-feeder mechanism.

Regardless of memory capacity, when only one sheet is printed double-sided, the sheet is turned over after one side is printed and re-fed for printing on the other side (rear face). In addition, when a double-sided copying is made by scanning a document with a scanner, the printing is made while the document is being scanned. Since the page sequence cannot be changed in this case, it is repeated in many cases to turn over the sheet after one side is printed and then re-feed it for printing on the other side, when two or more document pages are scanned for double-sided copying.

When the sheet is turned over after one side is printed and then re-fed for printing on the other side and therefore the transport path in the sheet turnover mechanism and the re-feeder mechanism holds only one sheet at a time, it takes a time to turn over and re-feed the paper. Then the power to the charger for the electro-photographic process is suspended, or the heater for fixing is deactivated to prevent the image carrier from wearing and unnecessary heater operation (for example, Japanese Patent Application Laid-open No. 8-320642).

However, in such a double-sided image forming apparatus, there will be a significant difference in the rotation time of the photosensitive drum per sheet between continuous double-sided printing and double-sided printing on only one sheet.

FIG. 2 is a timing chart for continuous double-sided printing in the prior art image forming apparatus, illustrating the timing chart for continuous 4-sheet double-sided printing. FIG. 3 is a timing chart for one-sheet double-sided printing in the prior art image forming apparatus.

In general, after AC voltage and DC voltage for charging are raised to prescribed values, DC high-voltage is applied as the bias voltage for development in the pre-rotation process, and then AC high-voltage is applied in the printing process as the bias voltage for development. Transfer high-voltage is applied when sheet P passes the transfer unit. During the interval of sheet printing, the AC high-voltage for development is lowered and the transfer high-voltage is also lowered to a level for the interval. When the last page is printed, the post-rotation process starts, and the transfer high-voltage, DC high-voltage for development, DC high-voltage for charging and AC high-voltage for charging are lowered in this order.

In FIG. 2, when a first side of the first sheet is printed and the sheet has reached to the turn-over point, a first side of the second sheet is printed. When the first sheet has reached the transport unit in the turn-over unit and the second sheet has reached the turn-over point, a first side of the third sheet is printed, and then the second side of the first sheet, a first side of the fourth sheet and the second side of the second sheet are printed sequentially. When the second side of the third sheet and the second side of the fourth sheet are printed in a row, the double-sided printing on four sheets is over.

Referring now to FIG. 2, because printing is completed in a short time in continuous double-sided printing, the interval period of time per sheet does not much affect the life of the photosensitive drum 1. The life is as long as that of the drum used in continuous single-sided printing.

On the other hand, when double-sided printing is repeated for each single sheet, the steps of printing on a first side, paper interval, and printing on the second side are repeated, as shown in FIG. 3. Such operation is seen when the memory does not have a capacity large enough to store the image data of plural pages or when an image forming apparatus equipped with a read scanner conducts double-sided copying. During the time interval between printing on a first side and printing on the other side, namely, the period of time from the turn-over of sheet P to its re-feeding, the photosensitive drum 1 keeps rotation. Because usually it takes as much time as printing two or three pages to turn over sheet P and re-feed it, the life of the photosensitive drum 1 becomes equally shorter.

The image forming apparatus are expected to run faster and faster. Thus if the next feed process is started after the feeding of each previous sheet is completed, the feeding speed itself must be raised. Otherwise, even if the feeding speed is raised, there will be a limit to throughput.

To solve such problems, printing data is stored in a printing data reservation memory, and as soon as the printing requirements are met paper is fed for printing based on the data stored in the memory, in order to feed not only the next sheet but also further latter sheets at a time (hereinafter, preliminary feeding; for example, Japanese Patent Application Laid-open Nos. 2002-046876, 2001-192132, 2001-088406 and 2001-088370). By virtue of this improvement, throughput can be easily maximized without raising the paper feeding speed too much or raising print cost, even when the transport path for recording sheets is rather long.

In many printers, a single driving source (motor) is used to rotate the image carrier and transport rollers for lower cost; the motor is directly connected to the driver of the image carrier, while its connection to transport rollers is switched by a clutch. In the image forming apparatus of such structure, the sheet is turned over after its first side is printed and then re-fed for printing on the other side. Then a single sheet is held for double-sided printing in the transport path in the sheet turn-over mechanism and the re-feeder mechanism. If the abovementioned preliminary feeding is adopted in this system to maximize throughput, the following problems arise.

If a single sheet is to be printed double-sided, it is possible to stop the rotation of the image carrier by suspending high-voltage for electrophotography while the one-side printed sheet is turned over and fed again. However, in the case of continuous double-sided printing of plural sheets, the transport rollers must be kept rotating for preliminary feeding of the subsequent sheets, while the one-side printed sheet is turned over and fed again. Since the image carrier shares the driving source with the transport rollers, its rotation cannot be stopped during preliminary feeding.

As a result, throughput can be maximized with no cost-up, but such a problem is in turn posed that the image carrier wears fast and comes to the end of its life early because it keeps rotation and receives high-voltage while the one-side printed sheet is turned over and re-fed.

In cases other than double-sided printing, a similar problem will arise when the paper interval is long in usual single-sided printing.

### SUMMARY OF THE INVENTION

The present invention has been made to solve such problems, and provides an image forming apparatus where the life of the image carrier does not become significantly short even when the distance between individual sheets is rather long.

Another objection of the invention is to provide an image forming apparatus that can extend the life of the image carrier while maintaining the maximized throughput.

To attain such these objection, forming an electrostatic latent image on an image carrier, the present invention has an image forming apparatus comprising: a charging unit for charging the image carrier; a charge voltage loading unit for applying charge voltage to the charging unit; an exposure unit for exposing the image carrier charged by the charging unit to form an electrostatic latent image corresponding to image signals; a development unit for forming a toner image by developing the electrostatic latent image formed on the image carrier by the image carrier; an image transfer unit for continuously transferring the toner image formed by the development unit onto a plurality of recording materials; and a control unit for controlling ac charge voltage applied by the charge voltage loading unit to the charging unit, wherein, when the transport interval of the plural recording materials is shorter than a predetermined time the AC charge voltage applied to the image carrier during the transport interval being a first AC charge voltage, and when the transport interval is longer than the predetermined time the ac charge voltage applied to the image carrier during the transport interval being a second AC charge voltage, the control unit makes the current running in the charging unit to which the second charge voltage is applied lower than the current running in the charging unit to which the first AC charge voltage is applied.

The image forming apparatus that forms an electrostatic latent image on an image carrier, comprising: a charging unit for charging the image carrier; a charge voltage loading unit for applying charge voltage to the charging unit; an exposure unit for exposing the image carrier charged by the charging unit and forms an electrostatic latent image corresponding to image signals; a development unit for forming a toner image by developing the electrostatic latent image formed on the image carrier by the image carrier; an image transfer unit for continuously transferring the toner image formed by the development unit onto a plurality of recording materials; a fixer unit for fixing the toner image transferred by the image transfer unit to the recording material; a transport unit for transporting the recording material to the image transfer unit to transfer a toner image onto the other side of the recording material where a toner image has been fixed by the fixer unit; and a control unit for controlling ac charge voltage applied by the charge voltage loading unit to the charging unit, wherein, while the transport unit is not transporting the recording material the AC charge voltage being a first AC charge voltage, and while the transport unit is transporting the recording material the AC charge voltage being a second AC charge voltage, the control unit makes the current running in the charging unit to which the second charge voltage is applied lower than the current running in the charging unit to which the first AC charge voltage is applied.

The image forming apparatus that forms an electrostatic latent image on an image carrier, comprising: a charging unit for charging the image carrier; a charge voltage loading unit for applying charge voltage to the charging unit; an exposure unit for exposing the image carrier charged by the charging unit and forms an electrostatic latent image corresponding to image signals; a development unit for forming a toner image by developing the electrostatic latent image formed on the image carrier by the image carrier; an image transfer unit for continuously transferring the toner image formed by the development unit onto a plurality of recording materials; a fixer unit for fixing the toner image transferred by the image transfer unit to the recording material; a feeder unit for feeding the recording material from a recording material container where a plurality of recording materials are loaded; a transport unit for transporting the recording material to the image transfer unit to transfer a toner image onto the other side of the recording material where a toner image has been fixed by the fixer unit; a control unit for controlling AC charge voltage applied by the charge voltage loading unit to the charging unit; and a memory unit for storing the image formation conditions about the plural recording materials based on the command sent from an external device, wherein, while the transport unit is not transporting the recording material, the AC charge voltage being a first AC charge voltage, and while the transport unit is transporting the recording material and the feeder unit is feeding the recording material subsequent to said recording material based on the image formation conditions stored in the memory unit, the AC charge voltage being a second AC charge voltage, the control unit makes the current running in the charging unit to which the second charge voltage is applied lower than the current running in the charging unit to which the first AC charge voltage is applied.

According to the above configuration, it becomes possible to prevent the image carrier from wearing by an optimized control based on individual print conditions such that only a single side is printed, alternative double-sided print holding plural sheets in a standby status in the turn-over unit, and double-sided printing is conducted while only one sheet is held in the turn-over unit.

According to the above configuration, it becomes possible to prevent the image carrier from wearing while minimizing the decrease in throughput by conducting preliminary paper feeding upon the resumption of image carrier rotation even when a print reservation is made during the period while the paper is under transport for double-sided printing and the rotation of the image carrier is suspended.

According to the present invention related with an image forming apparatus that charges the image carrier by contacting a voltage-loaded charging material thereto, it becomes possible to reduce the wear of the image carrier and thereby significantly extend its useful life by lowering AC voltage or ac current applied to the charging unit when it is known in advance that the paper interval during continuous printing becomes longer than usual.

Furthermore, if any subsequent print job is reserved, the preliminary feeding of paper is conducted for the reserved job during the time while the first sheet is turned over and transported to the position of re-feeding for double-sided printing in the interval between printing on its first side and printing on the other side to maximize throughput with no rise in cost. No preliminary paper feeding becomes necessary when no subsequent print job is reserved when the first sheet is turned over and transported to the position of re-feeding for double-sided printing in the interval between printing on its first side and printing on the other side. Thus, during this period, both dc and AC voltages are terminated and the rotation of the photosensitive drum is suspended to further reduce the wear of the photosensitive drum. As a result, the throughput is maintained high with no rise in cost, and the wear of the photosensitive drum is prevented in the optimized manner by controlling the drum rotation and voltage output for charging corresponding to individual conditions for double-sided printing. In addition, energy saving effects are provided by eliminating unnecessary drum operation and charging power.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a schematic structure of the prior art image forming apparatus;

FIG. 2 is a timing chart for continuous double-sided printing in the prior art image forming apparatus;

FIG. 3 is a timing chart for single-sheet double-sided printing in the prior art image forming apparatus;

FIG. 4 is a schematic structure of the image forming apparatus of a first embodiment of the invention;

FIG. 5 is a diagram of an embodiment of the high-voltage output circuit for charging;

FIG. 6 is a characteristic chart of AC voltage for charging and charge current;

FIG. 7 is a characteristic chart of charge current and potential of the photosensitive drum;

FIG. 8 is a timing chart for the image forming apparatus of the first embodiment;

FIG. 9 is a schematic structure of the image forming apparatus of a second embodiment of the invention;

FIG. 10 is a characteristic diagram illustrating the step-down and step-up of charge current;

FIG. 11 is a timing chart for continuous single-sided printing in the second embodiment of the image forming apparatus equipped with a plurality of paper feeder ports;

FIG. 12 is a timing chart for continuous double-sided printing in the second embodiment of the image forming apparatus equipped with a plurality of paper feeder ports;

FIG. 13 is a timing chart for the image forming apparatus of a third embodiment;

FIG. 14 is a schematic structure of the image forming apparatus of a fourth embodiment and a fifth embodiment of the invention;

FIG. 15 is a block diagram (No. 1) illustrating the functions of the fourth and fifth embodiments;

FIG. 16 is a block diagram (No. 2) illustrating the functions of the fourth and fifth embodiments;

FIGS. 17A-17K are diagrams illustrating the print reservation tables for the image forming apparatus of the fourth embodiment;

FIG. 18 is a timing chart for printing in the image forming apparatus of the fourth embodiment;

FIG. 19 is a flowchart showing the relationship of FIGS. 19A and 19B;

FIG. 19A is a flowchart (No. 1) illustrating the printing operation of the engine controller of the image forming apparatus of the fourth embodiment;

FIG. 19B is a flowchart (No. 2) illustrating the printing operation of the engine controller of the image forming apparatus of the fourth embodiment;

FIGS. 20A-20K are diagrams illustrating the print reservation tables (double-sided printing on two pages) for the image forming apparatus of the fifth embodiment;

FIG. 21 is a time chart (double-sided printing on two sheets) in the image forming apparatus of the fifth embodiment;

FIGS. 22A-22M are diagrams illustrating the print reservation tables (double-sided printing on two pages plus single-sided printing) for the image forming apparatus of the fifth embodiment;

FIG. 23 is a time chart (double-sided printing on two pages and single-sided printing) in the image forming apparatus of the fifth embodiment; and

FIG. 24 is a flowchart showing the relationship of FIGS. 24A and 24B;

FIG. 24A is a flowchart (No. 1) illustrating the printing operation of the engine controller of the image forming apparatus of the fifth embodiment; and

FIG. 24B is a flowchart (No. 2) illustrating the printing operation of the engine controller of the image forming apparatus of the fifth embodiment.

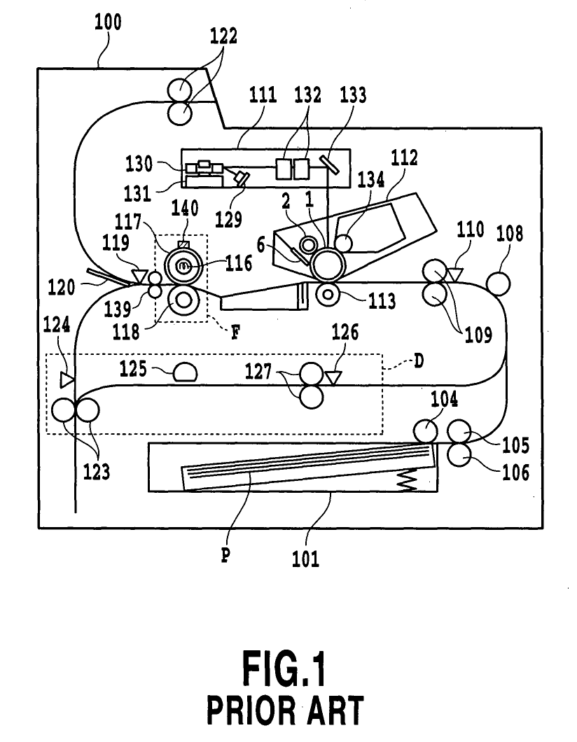

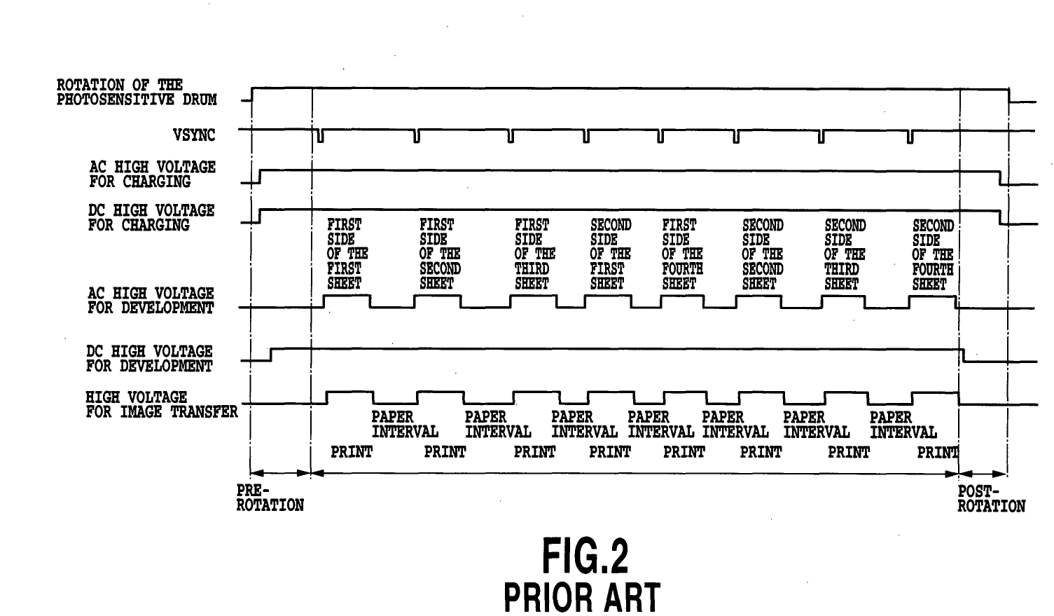

### DETAILED DESCRIPTION OF PREFERRED EMBODIMENTS

Now the preferred embodiments of the present invention will be described with reference to the accompanying drawings.

[Embodiment 1]

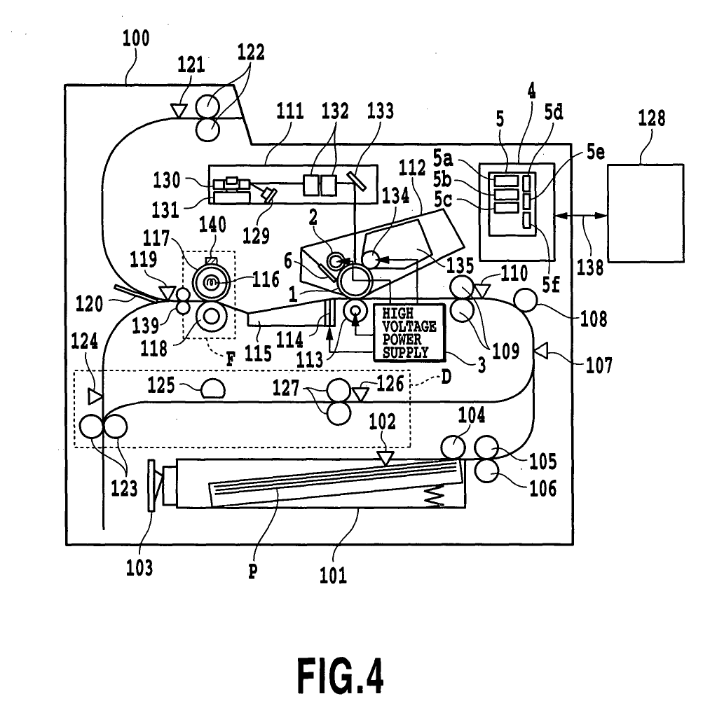

FIG. 4 is a schematic structure of a laser beam printer that is an embodiment of the image forming apparatus of the invention.

The laser beam printer 100 of this embodiment has a paper cassette 101 holding recording material, namely, recording paper P, a paper cassette paper detection sensor 102 that detects the presence/absence of recording paper P in the paper cassette 101, a paper size sensor 103 that detects the size of recording paper P in the paper cassette 101, a pickup roller 104 that picks up recording paper P from the paper cassette 101, a transport roller 105 that conveys recording paper P picked up by the pickup roller 104, and a retard roller 106 that is paired with the transport roller 105 and prevents recording paper P from being conveyed in stack.

In the downstream of the feeder roller 105 installed are a paper feeder sensor 107 that monitors the state of paper sheets transported from a turn-over unit D (to be described later), a paper transport roller 108 that conveys recording paper P to further downstream, a pair of resist rollers 109 that convey recording paper P in synchronization, and a pre-resist sensor 110 that monitors the state of recording paper P transported to the resist roller pair 109.

In the downstream of the resist roller pair 109 installed are a process cartridge 112 that forms a toner image on the photosensitive drum 1 by the use of laser light from a laser scanner 111 (to be described later), a transfer roller 113 that transfers the toner image formed on the photosensitive drum 1 onto recording paper P, and a discharge unit 114 (hereinafter, discharge wire) that facilitates the charge removal from recording paper P and thereby helps it leave the photosensitive drum 1.

Further in the downstream of the discharge wire 114 installed are a transport guide 115, a fixer unit F having a pressure roller 118 and a fixer roller 117 equipped therein with a halogen heater 116 for thermally affixing the toner image transferred to recording paper P., fixer exit rollers 139, a fixer unit sensor 119 that monitors the state of paper sheets transported from fixer unit F, and a flapper 120 that switches the path of recording paper P sent from fixer unit F to either the output unit or turnover unit D for double-sided printing. In the downstream on the output side, a paper output sensor 121 that monitors the state of paper sheets sent to the output unit and a pair of output rollers 122 for ejecting recording paper are installed.

The turn-over unit, D, for double-sided printing turns over recording paper P, of which either side has been printed, for printing on the other side, and sends it to the image forming unit again. This turnover unit D has a pair of reverse rollers 123 that switch back recording paper P by rotating in forward/reverse directions, a reverse sensor 124 that monitors the state of recording paper P transported to the reverse roller pair 123, a D-cut roller 125 that transports recording paper P from a transverse resist unit (not shown) that aligns recording paper P in the transverse direction, a turn-over unit sensor 126 that monitors the state of recording paper P in turn-over unit D for double-sided printing, and a pair of transport rollers 127 in turn-over unit that transport recording paper P from turn-over unit D to the feeder unit.

The scanner 111 has a laser unit 129 that emits laser light modulated by image signals sent from an external device 128 (to be described later), a polygon mirror 130 and a scanner motor 131 for scanning later light of the laser unit 129 on the photosensitive drum 1, an image formation lens assembly 132, and a return mirror 133.

The process cartridge 112 has a photosensitive drum 1 needed for common electro-photography, a charging roller 2 working as a charger, a development roller 134 and a toner cassette 135 that work as a developer, and a cleaning blade 6 that is a cleaning unit. The process cartridge is attached to the laser printer 100 detachably.

The laser beam printer 100 has a high-voltage power supply 3 and a printer controller 4. The high-voltage power supply 3 has a high-voltage output circuit for charging 30 (to be described later), a developer roller 134, a transfer roller 113, and a high-voltage output circuit that supplies a desired voltage to the discharge wire 114.

The printer controller 4 that controls the laser beam printer 100 has CPU 5 equipped with RAM 5a, ROM 5b, a timer 5c, a digital I/O port (hereinafter, I/O port) 5d, an analog-digital converter input port (hereinafter, A/D port) 5e and a digital-analog output port (hereinafter, D/A port) 5f, as well as input-output control circuits (not shown). The printer controller 4 is connected to an external device 128 such as a personal computer via an interface 138.

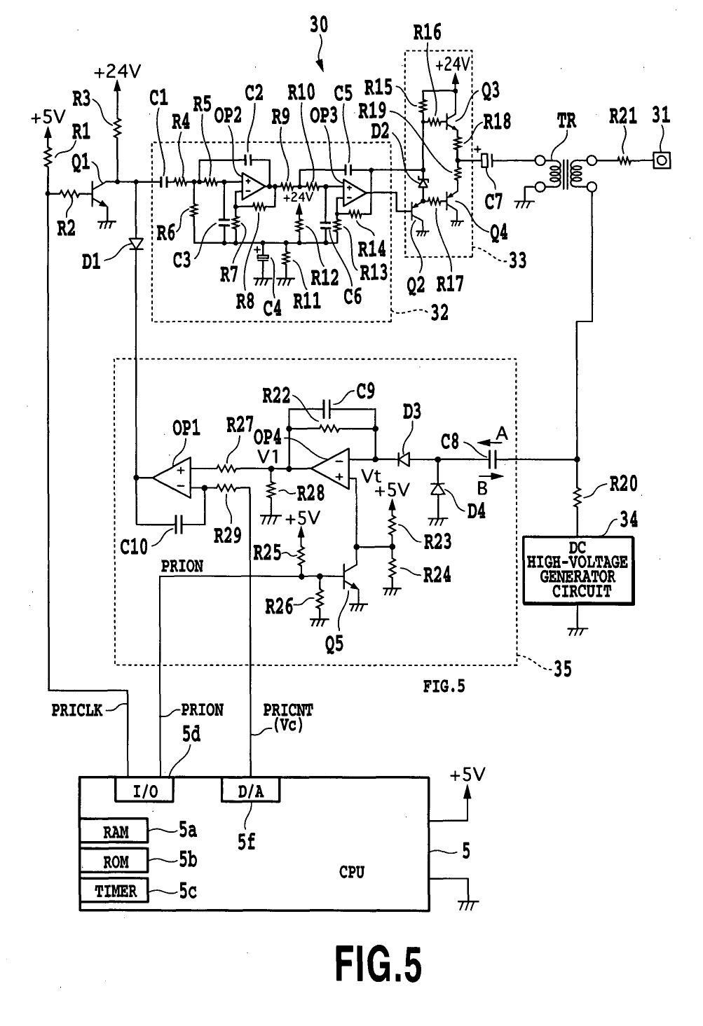

FIG. 5 is a diagram illustrating the structure of an embodiment of the charging high-voltage output circuit in the high-voltage power supply. The control of high-voltage output for charging by CPU 5 of the invention is explained with reference to this charging high-voltage output circuit 30.

The charging high-voltage output circuit 30 produces high-voltage for charging by overlapping charging AC high-voltage Vcac onto charging DC high-voltage Vcdc, and provides the output from the output terminal 31 of FIG. 5. The output terminal 31 is connected to the charging roller 2 that contacts the photosensitive drum 1.

When the I/O port 5d of CPU 5 provides clock pulses (PRICLK), transistor Q1 switches via a pull-up resistor R1 and a base resistor R2, and the pulses are amplified to have amplitudes corresponding to the output of an operation amp OP1 connected to a pull-up resistor R3 via a diode D1. The operation amp OP1 is part of a current detection unit 35 and will be explained in detail later. When the amplitudes of clock pulses are large, the amplitudes of sinusoidal driving voltage waves (voltage between peak to peak) provided to a high-voltage transformer TR (to be described later) become also large. Thereby voltage between peak to peak indicated the level of charging AC high-voltage Vcac is raised.

Clock pulses (PRICLK) are provided to the primary coil of high-voltage transformer TR via a filter circuit 32 and a high-voltage transformer driver circuit 33 of a push-pull type. Namely, the clock pulses (PRICLK) amplified by operation amp OP1 are sent to the filter circuit 32 via a capacitor C1, and the filter circuit 32 consisting of resistors R4-R14, capacitors C2-C6 and operation amps OP2, OP3 provides sinusoidal waves across +12V.

The output from the filter circuit 32 is entered to the primary coil of high-voltage transformer TR via the push-pull type high-voltage transformer driver circuit 33 equipped with a transistor Q2, a Zener diode D2, resistors R15-R19 and transistors Q3, Q4 and via a capacitor C7, to produce sinusoidal waves of charging AC high-voltage Vcac on the secondary coil side. One of the terminals of the secondary side of high-voltage transformer TR is connected to a charging DC high-voltage generator circuit 34 via a resistor R20. Thus the charging high-voltage V where charging AC high-voltage Vcac is overlapped on charging DC high-voltage Vcdc is provided from the output terminal 31 via an output protection resistor R21, and then supplied to the charging roller 2.

Next explained is the current detection unit 35 of the charging AC high-voltage circuit 30.

As described above, the charging AC current Iac produced by the charging AC high-voltage generator circuit 30 is provided to the current detection circuit, namely, the current detection unit 35. In this current detection unit 35, the charging AC current Iac from the charging AC high-voltage generator circuit 30 passes a capacitor C8, and the half-waves of direction A run through a diode D3, while the half-waves of direction B run through a diode D4. The half-waves of direction A that have passed the diode D3 are provided to an integral circuit composed of an operation amp OP4, a resistor R22 and a capacitor C9, and then converted into DC voltage.

Voltage at output (V1) in the operation amp OP4 is expressed by:

V1=−(Rs×Imean)+Vt (Eq.1)

where Imean is the mean of the charging AC current Iac half-waves, Rs the resistance of resistor R22, and Vt the voltage supplied to the positive input of operation amp OP4. This voltage, Vt, is a voltage provided by splitting the output (PRION) from the I/O port 5d of CPU 5 with transistor Q5 and resistors R23, R24.

The output from operation amp OP4 is connected to the positive input of operation amp OP1 for comparison with the level of current control signal (PRICNT) at the minus input. The current control signal (PRICNT) is a signal used to set the current level of the charging AC current Iac.

If the output voltage (V1) from operation amp OP4 is larger than setting voltage (Vc) used to set by the current control signal (PRICNT), the output from operation amp OP1 grows. As explained previously, when the output from operation amp OP1 grows, the amplitudes of clock pulses provided to the filter circuit 32 also grow and thereby voltage between peak to peak of the charging AC high-voltage Vcac becomes large.

Under such configuration, the voltage between peak to peak indicated voltage level of charging AC high-voltage Vcac is controlled so that the charging AC current Iac has a value corresponding to setting voltage Vc used to set by the current control signal (PRICNT). In other words, a constant current control is conducted according to the current control signal (PRICNT)

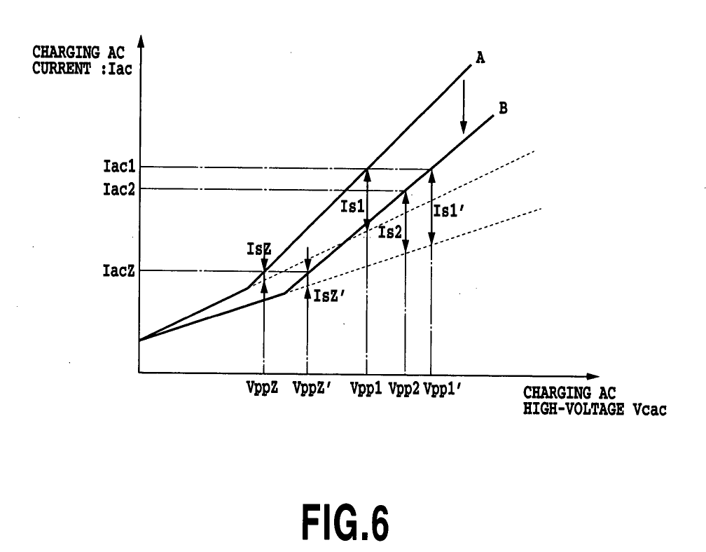

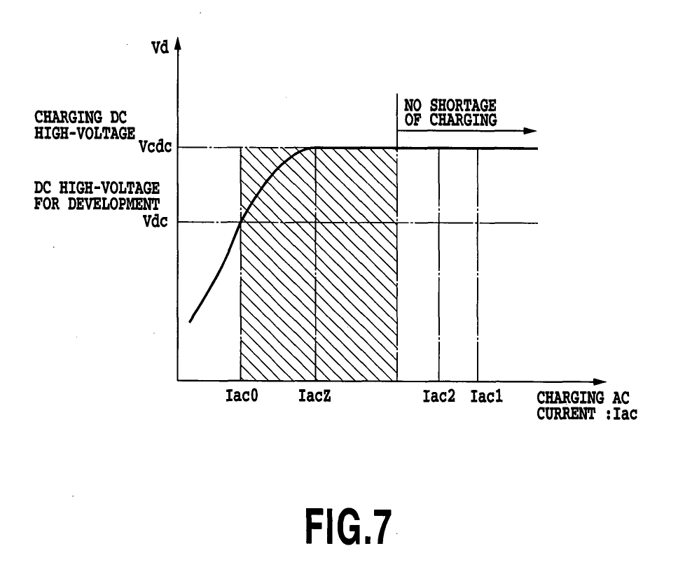

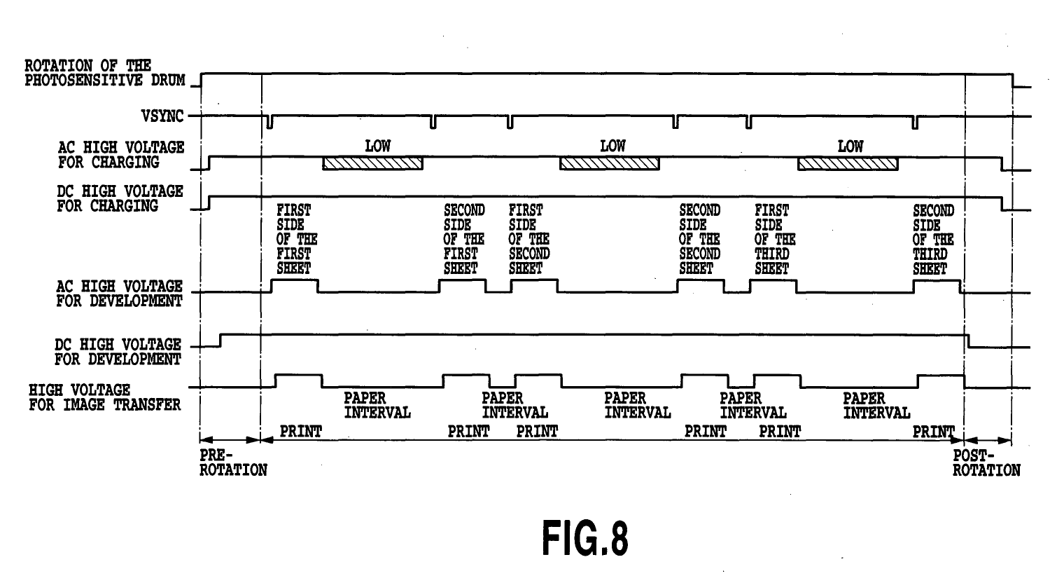

FIGS. 6-8 are diagrams illustrating the charging control in this embodiment: FIG. 6 is a characteristic chart of charging AC high-voltage Vcac and charging current Iac; FIG. 7 is a characteristic chart of charging current Iac and surface potential Vd of the photosensitive drum 1; and FIG. 8 is a timing chart for the image forming apparatus.

In FIG. 6, graph A shows the characteristics of early stages of photosensitive drum 1, while graph B the characteristic of the state after a lapse of significant time of photosensitive drum 1.

The charging AC current (Iac) running in the charging roller 2 steps up straightforwardly when the applied charging AC voltage Vcac of the charging roller 2 has low peaks, and further charging AC current (Iac) increases after passing a threshold for starting of discharge. Namely, the difference between the solid line and the broken line extrapolated from straight line of the early-stage of photosensitive drum 1 becomes the discharge current Is for charging. The constant current is controlled so that this discharge current Is for charging falls in a prescribed range. In general, when the discharge current Is for charging is low the image quality is impaired because of shortage of charging, while if the discharge current Is for charging is large then damage to the photosensitive drum 1 grows and it wears fast.

In this embodiment, by setting the current control signal from D/A port 5f at Vc1 at early stages of photosensitive drum 1, AC current Iac1 (applied AC voltage: Vpp1) as shown FIG. 6 is held constant by CPU 5 to provide a discharge current Is1. Meanwhile, when significant time has passed of photosensitive drum 1, it shows the characteristics of graph B. If applied AC voltage Vpp1′ is set so that the charge current Iac becomes Iac1, the discharge current of early stage of photosensitive drum 1 increases to Is1′ from Is1, and damage to the photosensitive drum 1 also increases. As a result, after a predetermined time of use, CPU 5 controls that the discharge current is set to Is2 (≈Is1) by changing the current control signal from D/A port 5f to Vc2 from Vc1 and the constant current (changing AC current) Iac to Iac2 (applied AC high-voltage Vcac≈Vpp2).

Now the relationship between charge AC current Iac and photosensitive drum potential Vd is explained with reference to FIG. 7. When current control signal (PRICNT) increases to setting voltage Vc by CPU 5, the discharge current Is for changing also increases according to the characteristics shown in FIG. 6 and potential Vd of the photosensitive drum 1 increases, approaching to changing DC high-voltage Vcdc applied to the charging roller 2. With charge current Iac1 (Iac2) for setting the discharge AC current Is for changing at a prescribed value Is1 (Is2), the potential Vd of the photosensitive drum 1 is sufficiently stabilized and poor charging does not occur (region indicated by arrow as shown FIG. 7).

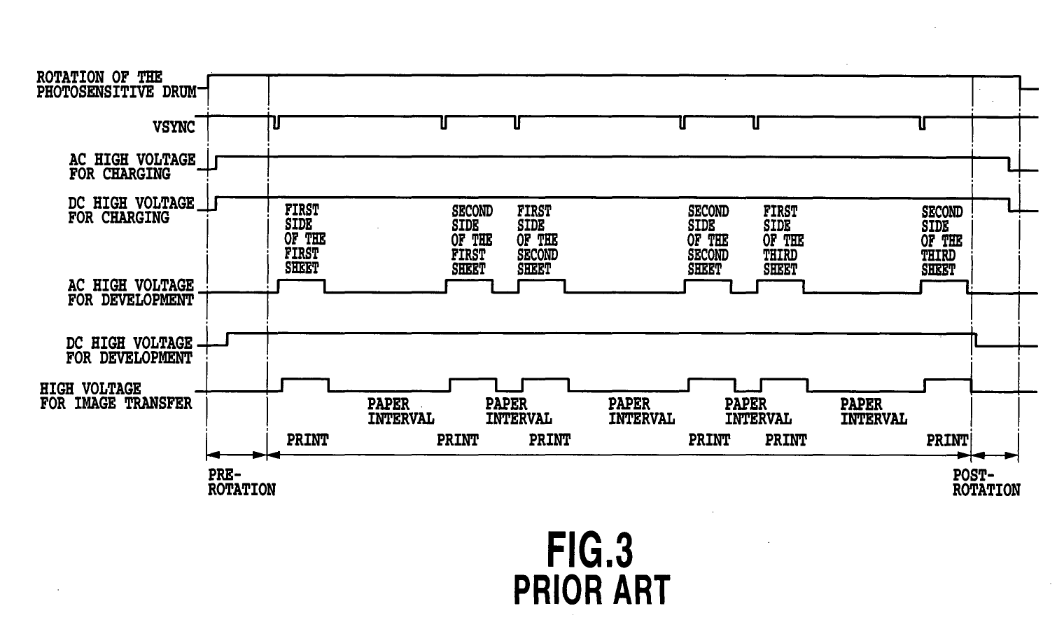

Charging control by CPU 5 conducted during double-sided printing of recording paper P is explained with reference to FIG. 8. Much like FIG. 3, FIG. 8 shows a timing chart for double-sided continuous printing to print either side and then print the other side on each of three recording paper P.

When it has been decided to print either side of recording paper P and then print the other side of recording paper P like this example, the charging AC high-voltage Vcdc for charging is kept, while the period of time the sheet (hereinafter transporting for double-side printing) is printed one-sided, turned over and re-fed, at a value (hereinafter, LOW value) lower than that running during printing process.

This LOW setting is a setting of voltage Vc in the current control signal (PRICNT) provided from the D/A port 5f of CPU 5 at a voltage VcZ which is lower than the voltage Vc1 adopted during printing by the photosensitive drum 1 onto recording paper P. As described later, a predetermined time is needed from the time voltage Vc in the charge current signal (PRICNT) is switched to the time charge current Iac running in the charging roller 2 has stabilized at a constant value. Thus during the step-down of charge voltage, charge current Iac changes from Iac1 to IacZ after a predetermined time Tdn has passed since CPU 5 switched voltage Vc in the current control signal (PRICNT) from Vc1 for printing (Vc2 after the photosensitive drum 1 has been used for a sufficiently long time) to VcZ for the LOW setting. Meanwhile, during the step-up of charge voltage, charge current Iac changes from IacZ to Iac1 (Iac2 after the photosensitive drum 1 has been used for a sufficiently long time) after a predetermined time Tup has passed since CPU 5 switched voltage Vc in the current control signal (PRICNT) from VcZ for the LOW setting to voltage Vc1 for printing (Vc2 after the photosensitive drum 1 has been used for a sufficiently long time).

This charging AC current Iacz at LOW value as shown in FIG. 7 (hatched area) is a current level that causes poor charging if adopted during printing and sufficiently lower than charging AC current Iac1 and Iac2 during printing.

Then the discharge current Is for early stages where the charging AC current Iac is IacZ and the discharge current Is running after a sufficient time of using the photosensitive drum 1 become IsZ and IsZ′, respectively. The discharge current Is become IsZ and IsZ′, respectively during printing. Since the difference in discharge current between IsZ and IsZ′ is lower than that between Is1 and Is2 during printing, the discharge current Ic increases after a sufficient time of using photosensitive drum 1, then the wear of the photosensitive drum 1 is reduced.

Even when two or more values for constant current control can be set in the charging roller 2, the system structure and control sequence are simplified in first embodiment by setting only one value for the AC voltage for charging during the interval during double-sided printing.

Meanwhile, by setting photosensitive drum potential Vd at a value larger than DC voltage Vdc for development, it becomes possible to prevent toner pick-up to the white areas of the photosensitive drum 1 and avoid contamination of the transfer roller 113 by toner and waste of toner. In other words, by setting (LOW value) the charging AC current Iac for paper interval (during double-sided printing) at a value in the hatched area of FIG. 7, such troubles can be avoided and wear of the photosensitive drum 1 can be reduced.

Furthermore in this embodiment, switching of the charging AC current Iac to the LOW value is carried out between the time the first side is printed and the time the paper is re-fed for printing on the second side, with reference to the vertical synchronization signal of image (VSYNC). This switching may be done based on the signals from the fixer unit sensor 119, the reverse sensor 124 in the turn-over unit and the turn-over unit sensor 126.

In this embodiment, the period of time of LOW setting of charging AC current during double-sided printing on one recording paper P accounts for 50% of the total charge time. Wear of the photosensitive drum 1 during the LOW setting is less by 30% than that during the regular setting (unless LOW setting). As a result, the life of the photosensitive drum 1 is extended by 15% in total at double-sided printing on one recording paper P.

When using an image forming apparatus equipped with such a life detection means for estimating the useful life of the photosensitive drum 1 as shown in, for example, Japanese Patent Application Laid-open No. 10-039691, the wear coefficient corresponding wear of photosensitive drum 1 per use-time during the LOW setting may be set at 0.7, considering the above 30% improvement in life, in comparison with 1.0 that is the wear coefficient for regular setting (unless LOW setting).

[Embodiment 2]

Now a second embodiment of the present invention is described below. In the above first embodiment for double-sided printing, what will be printed after a first side of a sheet has been printed is the other side of the same sheet. In other words, when double-sided printing is conducted sheet by sheet, charging AC high-voltage Vcac is lowered while the period of time the sheet is printed one-sided, turned over and re-fed, and wear of the photosensitive drum 1 can be reduced. The second embodiment will describe to wear of the photosensitive drum 1 can be reduced that can be used one-sided printing with regular printing operation unless double-sided printing on recording paper P.

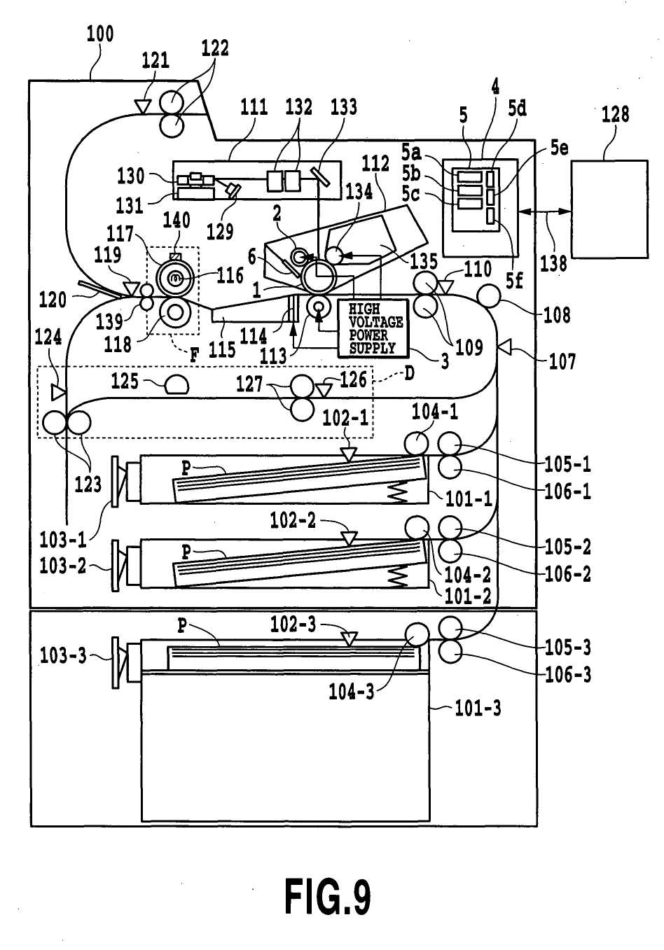

FIG. 9 is a schematic sectional view of the laser beam printer of the second embodiment of the invention. Its structure is very similar to that of the laser beam printer of the first embodiment shown in FIG. 4, it has three paper feeder cassettes 101-1, 101-2 and 101-3 for paper feeding. The components of the same structures and functions of the laser beam printer of the second embodiment have the same reference numbers throughout the figures, and their descriptions are not repeated.

In the second embodiment, the paper feeder cassettes 101-1 and 102-2 have the same specifications, while the cassette 101-3 is a deck type cassette of a larger capacity.

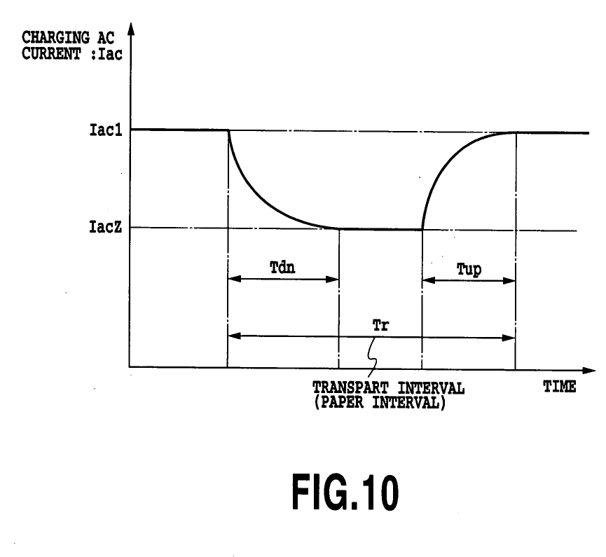

FIG. 10 shows the characteristics of the step-down and step-up of ac charge current observed when ac high voltage for charging Vcac is switched. When CPU 5 switches ac charge current Iac1 for printing to IacZ for the LOW setting for the transport interval (paper interval) between preceding recording paper P and subsequent recording paper P by controlling the ac high-voltage for charging, Vcac, which is loaded to the charging roller 2, ac current Iac1 for printing reaches ac charge current IacZ after step-down time Tdn has passed. Meanwhile, when IacZ for the LOW setting is switched to ac charge current Iac1 for printing, ac charge current IacZ reaches ac charge current Iac1 after the step-up time Tup has passed.

With a transport interval Tr between the moment the back end of preceding recording paper P passes the image transfer nip where the transfer roller 113 contacts the photosensitive drum 1 and the moment the front edge of subsequent recording paper P reaches the image transfer nip, this transport interval Tr must be long enough to cover both step-down time and step-up time of ac charge current Iac to conduct printing on recording paper P with no problem.

In general, during continuous printing for proceeding page data printing and subsequent page data printing, a print reservation (description of fourth embodiment) is made and paper feeding is completed earlier for higher throughput (output sheet number of recording paper P per use-time) when the next sheet to be printed is decided. Paper feeding operation of subsequent recording paper P is completed before the proceeding recording paper P is ejected out of printer. Recording paper P is held by the resist rollers 109, and the paper is re-fed with a predetermined timing to secure transport interval Ts for continuous printing.

Transport interval Tt of feeding paper in which tip of recording paper P picked up from paper feeder cassette 101 by the pick-up roller 104 reaches the resist rollers 109 and waiting time Tw for waiting to recording paper P in the resist rollers 109 to secure transport interval Tr are decided by the specifications of the employed image forming apparatus. Transport interval Tt of feeder paper become longer as Tt1<Tt2<Tt3 depending on each distance from the outlet of each of the paper cassettes 101-1, 101-2 and 101-3 to the resist rollers 109, where Tt1 is the transport time of feeder paper from the outlet of the paper cassette 101-1 to the resist rollers 109, and Tt2 and Tt3 are the times of transport for feeder paper from each outlet of the paper cassettes 101-2, 101-3 to the resist rollers 109.

Under such conditions, if a paper sheet comes from a different paper cassette 101 during continuous printing, namely if a paper sheet comes from a different cassette outlet, for example, if a paper sheet comes from the cassette 101-3 instead of the cassette 101-1, the transport interval Tt of feeder paper becomes longer by (Tt3−Tt1). Then CPU controls that the charging AC current Iac is altered as explained above during the transport time of feeder paper when Ts+(Tt3−Tt1)>(Tup+Tdn).

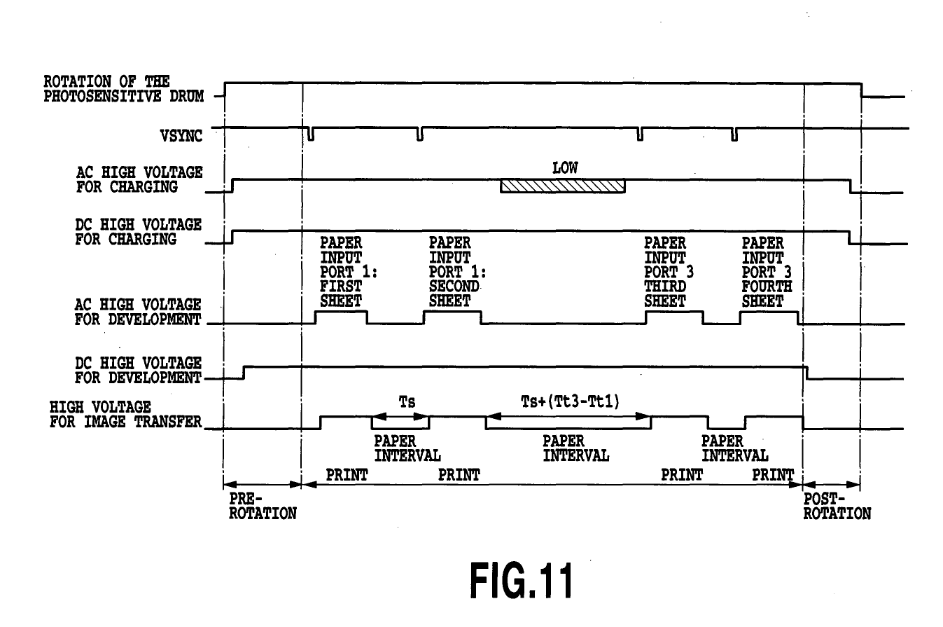

FIG. 11 is a timing chart for single-sided continuous printing in the image forming apparatus of the second embodiment having more than one cassette outlet. This is a timing chart for an operation in which the first and second sheets are fed from the cassette 101-1 and then the third and fourth sheets are fed from the cassette 101-3.

In this case, the CPU 5 controls that the charging AC current Iac is set to the LOW value during the paper interval between the second sheet of recording paper P and the third sheet of recording paper P when the cassette outlets have been switched. As a result, the life of the photosensitive drum 1 is prolonged by 30% by virtue of the LOW setting like the first embodiment. This effect of prolonging the useful life of the photosensitive drum 1 is enhanced when the print system switches the cassette outlets frequently.

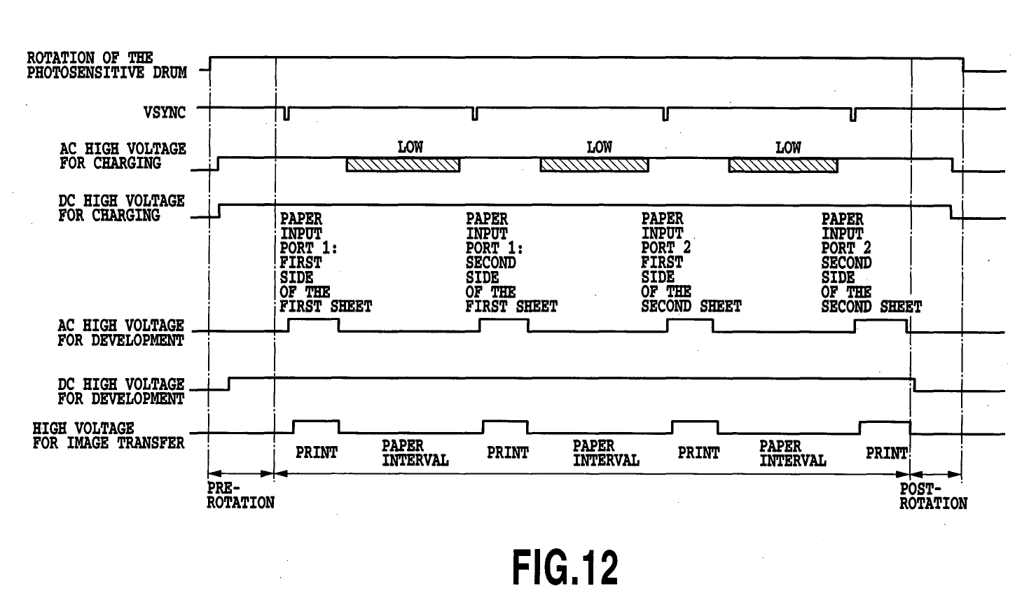

FIG. 12 is a timing chart for double-sided continuous printing in the image forming apparatus having more than one cassette outlet of the second embodiment.

When the paper feeder cassettes 101 or cassette outlets are switched during double-sided printing, namely, when the first sheet is sent from the paper cassette 101-1 for double-sided printing and subsequently the second sheet is sent from the paper cassette 101-2 for double-sided printing, the ratio of time of LOW setting in transport time of feeder paper increases and thereby the effect of prolonging the life of the photosensitive drum 1 is improved.

[Embodiment 3]

Now a third embodiment of the present invention is described below. Occasionally, paper sheets of rough surface (rough paper) are used in the image forming apparatus. Since its rough surface makes it harder for heat to move from the fixer roller 117, its fixing performance (degree of fixing toner on the recording paper) is inferior to that of paper having smooth surface. Thus throughput (output number of recording paper P per use-time) is lowered to improve fixing performance when rough paper is printed. In general, the temperature of the surface of the pressure roller 118 can be raised by lowing throughput by 30-50%. Then more heat moves to the rough paper, and fixing performance is thereby improved.

When such a special setting (hereinafter, referred to as the special sequence) is adopted in fixer F in this way, if the recording material transport interval is extended by changing the transport interval between preceding recording paper P and subsequent recording paper P, the time for applying ac charge voltage Vcac to the photosensitive drum 1 during the formation of an image (printing) on a recording paper sheet P becomes long. The longer the time of loading ac charge voltage Vcac, the more the life of the photosensitive drum 1 is affected. In the third embodiment, the method of preventing negative impact on the useful life of the photosensitive drum 1 is explained for the case where the transport interval between paper sheets P becomes long because of such a special sequence.

When a continuous printing is made by such a special sequence, it is known in advance that the paper transport interval between sheets P will be long. When the image forming apparatus or the host computer has adopted a special sequence, the ac charge current, Iac, is set at the LOW value during the transport interval of recording paper P even in single-sided continuous printing. Namely, CPU 5 applies the LOW setting to ac charge current Iac during the transport interval of recording paper sheets P.

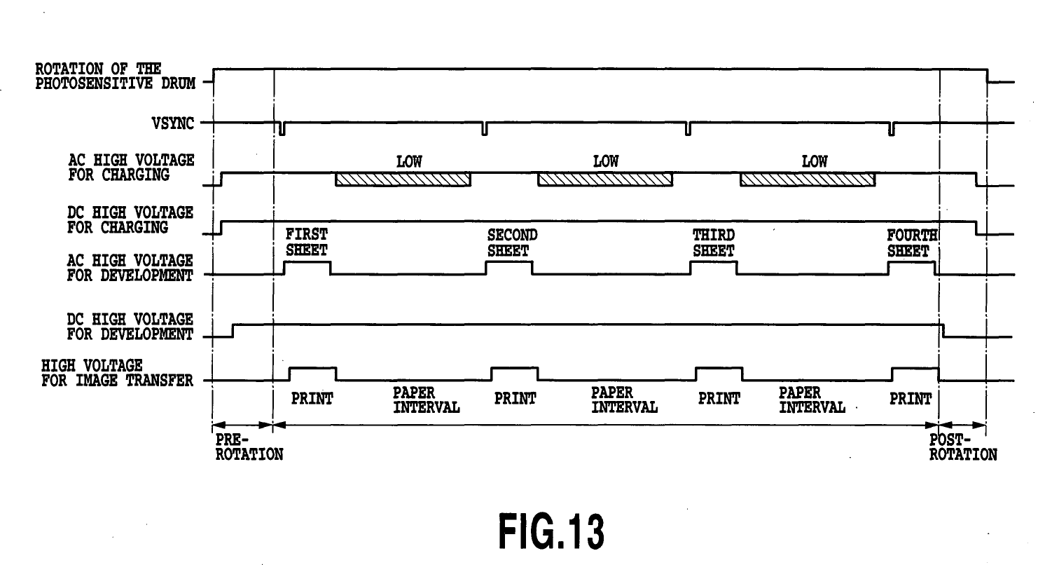

FIG. 13 is a timing chart for the image forming apparatus of a third embodiment of the invention, the timing chart of a special sequence for single-sided three-page continuous printing. The transport interval of proceeding recording paper P and subsequent recording paper P is spread. By lowering throughput by 40%, the transport interval per sheet increases about 400%. If the charging AC current Iac becomes the LOW setting that is adopted during those intervals, the useful time of the photosensitive drum 1 is significantly prolonged in comparison with unless LOW setting.

As indicated by the above embodiments:

(1) When the paper interval becomes rather long, the AC voltage (current) applied to the charging unit is set at a value lower than that applied during printing (during image formation), to reduce the wear of the photosensitive drum and extend its useful life.

(2) When it is known in advance that the paper interval becomes longer than a prescribed time during continuous printing of plural pages, the AC voltage (current) applied to the charging unit during paper intervals is lowered to the level that impairs image quality if adopted in regular printing.

(3) Unnecessary pick-up of toner can be avoided by setting the photosensitive drum potential during paper intervals, which results from the AC voltage (current) applied to the charging unit, at a value higher than the DC voltage for development.

(4) When AC voltage (current) is applied to meet the above requirements in such an image forming apparatus that can set plural AC voltage (current) values meeting the above requirements for paper intervals considering fluctuations in conductivity in the charging unit, one value of AC voltage (current), regardless of the number of those variable settings, is adopted for simplicity.

(5) When it is known that the rotation time of the photosensitive drum during each paper interval becomes longer than the sum of the step-up time and step-down time of AC voltage (current) applied to the charging unit, the AC voltage (current) applied to the charging unit is lowered during paper intervals.

(6) When double-sided printing is conducted on one sheet at a time during double-sided printing, or it is known that a first side is printed and then the other side is printed per sheet, the charge voltage (current) is lowered during paper turn-over for double-sided printing.

(7) When a continuous printing is conducted using two or more paper cassettes, the charge voltage (current) is lowered during paper intervals if the paper intervals become longer than usual.

(8) When throughput is lower than regular continuous printing, the charge voltage (current) is lowered during paper intervals.

Now fourth and fifth embodiments of the invention will be described below with reference to the accompanying drawings.

[Embodiment 4]

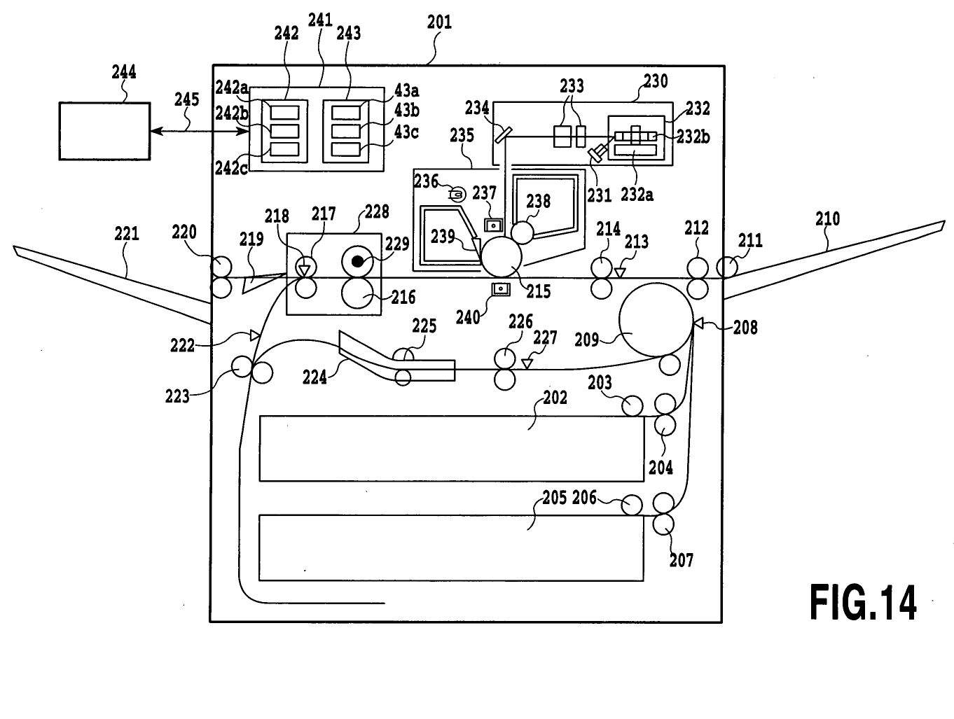

FIG. 14 is a schematic diagram illustrating the structure of the image forming apparatus of a fourth embodiment, exemplifying a laser printer. The printer 201 has a top cassette 202 and a bottom cassette 205 that hold recording paper P. The top pickup roller 203 for the top cassette 202 picks up recording paper and the top transport roller 204 transports to the recording paper P. The bottom pickup roller 206 for the bottom cassette 205 picks up recording paper P and the bottom transport roller 207 transports to the recording paper P. The recording paper P transported from the top cassette 202 or the bottom cassette 205 is detected by a feeder sensor 208 in the downstream, and further transported by the re-feeder rollers 209.

Also from the multi-tray 210 holding recording paper P, the multi-pickup roller 211 picks up recording paper P and the multi-transport roller 212 transports the recording paper P. The recording paper P transported from the top cassette 202, bottom cassette 205 and multi-tray 210 is detected by a resist sensor 213 in the downstream. Paper transport is suspended when a predetermined loop is made for the resist roller pair 214. In synchronization with the image formation timing (VSYNC signal), the resist roller pair 214 resumes transport of the recording paper P.

In the downstream at transport direction of the resist roller pair 214, a process cartridge 235 is installed detachably so as to form toner images on the photosensitive drum (image carrier) 215 by the use of laser light arriving from the laser scanner 280. The toner image on the photosensitive drum 215 is printed onto the recording paper P by the transfer unit 240. In a further downstream at transport direction, a fixer unit 228 is installed to fix the toner image formed on the recording paper P by pressure and heat. In the downstream of the fixer unit 228, a fixer exit sensor 218 that monitors the state of transported paper and output rollers 217 that transport the recording paper P to the output tray 221. The recording paper P is ejected to a paper output tray 221 by the paper output rollers 220.

For double-sided printing, the flapper 219 guides the recording paper P to the turn-over unit 260. The recording paper P sent to the turn-over unit 260 is detected by the reverse sensor 222 and pulled in the turn-over unit 260 by the reverse rollers 223. When pulled in, the recording paper P is turned over by the reverse rotation of the reverse rollers 223 and sent to the transport unit 261 for double-sided printing. The recording paper p sent to the transport unit 261 in the turn-over unit 260 is further transported by a notch roller 225, and stops in the position where the notch of the notch roller 225 touches the recording paper P. When the recording paper P is released, the transverse resist adjustor plate 224 corrects its slanting. After that, the notch roller 225 resumes paper transport and the paper is further transported by the rollers 226 in the downstream at transport direction. The sensor 227 confirms the position of the transported paper. The recording paper P is transported by the re-feeder rollers 209 for image formation on the other side.

The laser scanner 230 consists of a laser unit 231 that emits laser light modulated by image signals sent from an external device 244, a scanner motor unit 232 that scans the laser light provided by the laser unit 231 on the photosensitive drum 215, an image formation lens assembly 233, and a return mirror 234. The scanner motor unit 232 consists of a scanner motor 232a and a polygon mirror 232b. The process cartridge 235 consists of the photosensitive drum 215 needed for electro-photography, a pre-exposure lamp 236, a charger 237, a developer 238, a transfer unit 240 and a cleaner 239.

The printer controller 241 is a device that controls the printer 201, composed of a video controller 242 and an engine controller 243. The video controller 242 mostly consists of a micro computer 242a, a timer 242b and a memory 242c. The engine controller 242 is composed of a micro computer 243a, a timer 243b and a memory 243c.

The printer controller 241 is communicated with an external device 244 (for example, a host PC) via an interface 245. Although not shown here, the printer 201 has a control panel 250 which shows useful information to the user or the user makes settings with. The fixer unit 228 is a thermal-roller type fixer unit consisting of a heat-pressure roller 216 composed of a thermal roller and a pressure roller and a heater 229 that is a halogen heater installed in the thermal roller. A temperature sensor is attached to the surface of the thermal roller to turn On/Off the heater based on the detected temperature and keep the roller surface temperature constant.

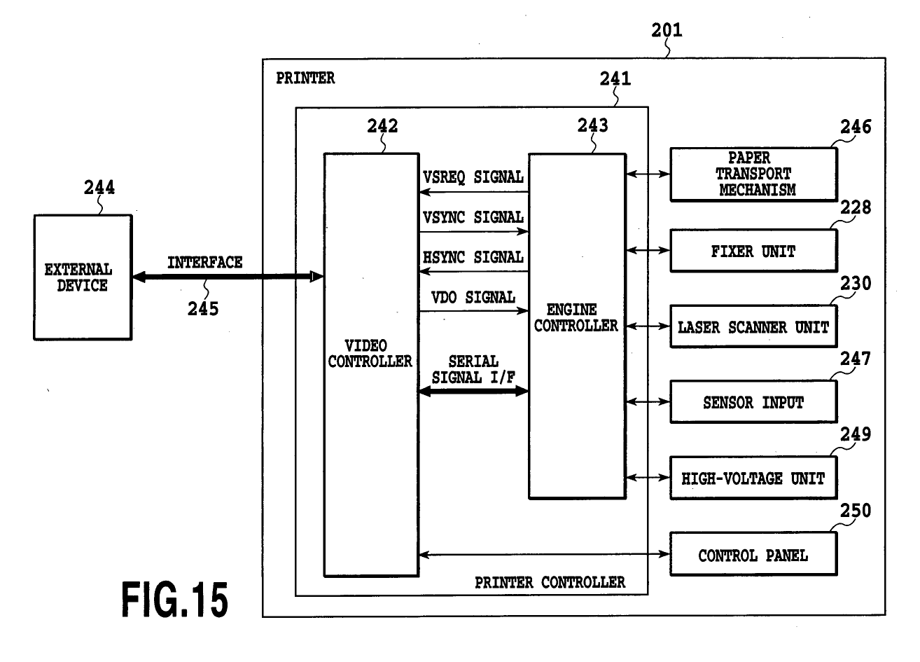

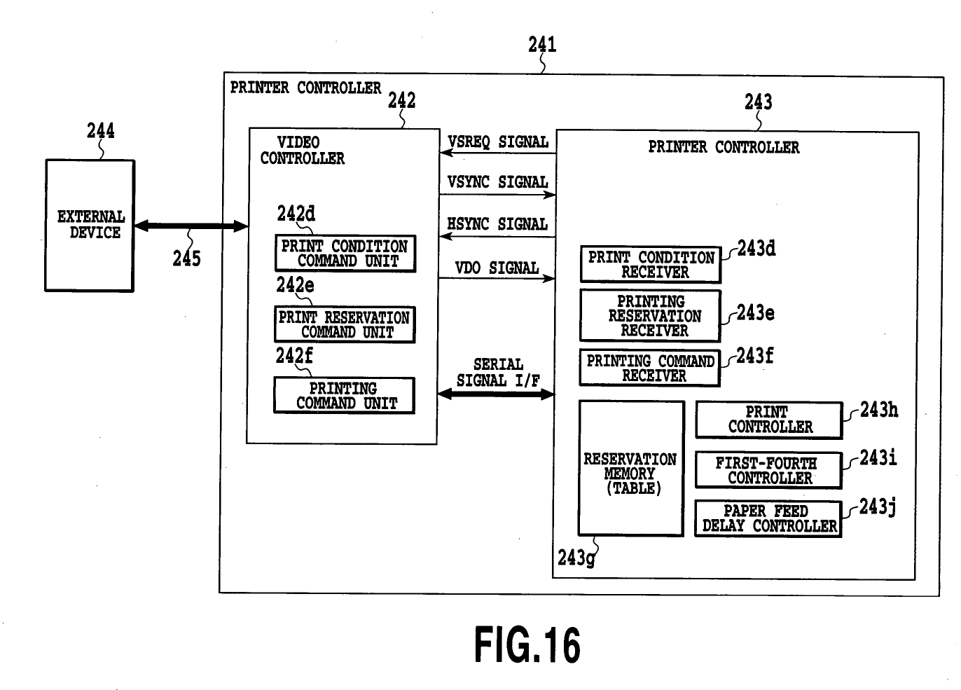

FIGS. 15 and 16 are function diagrams of a fourth embodiment. The printer 201 has the printer controller 241 that is composed of the video controller 242 and the engine controller 243. The video controller 242 translates the image data, which is sent from the external device 244 like a host computer via the interface 245, into bit data needed for printing.

The video controller 242 assigns an ID to each image in the engine controller 243 via a serial interface (I/F), and lets the print condition command unit 242d specify print conditions (feeder port for feeding paper P, output port for transport paper P, etc.), while the print reservation command unit 242e makes reservations for printing according to each ID. When the bit data has been translated, the video controller 242 sends an command of printing from the printing command unit 242f to the engine controller 243 to perform printing.

The engine controller 243 stores the print conditions and print reservation data in a reservation memory table 243g according to the print condition sent from the video controller 242 to the print condition receiver 243d and print reservation data received in the print reservation receiver 243e, and the print controller 243h controls printing. The engine controller 243 rotates the photosensitive drum 215 and feeds paper specified in the print conditions, controlling the paper transport mechanism 246 including the feeder roller, transport roller and lifter. In the high-voltage unit 249 controls by engine controller 243, the charger 237 applies charging high-voltage V (additional voltage of the charging AC high-voltage Vcac and charging DC high-voltage Vcdc) to uniformly charge (charging voltage Vd) the surface of the photosensitive drum 215, while the developer 238 applies DC high-voltage Vdc for development.

Based on the printing commands sent from the video controller 242, the printing command receiver 243f provides vertical synchronization request signals (VSREQ signal) and waits for vertical synchronization signals (VSYNC signals) sent from the video controller 242. Receiving the VSYNC signal, the engine controller 243 forms images, controlling the laser scanner 230 based on the video signals (VDO signals) sent from the video controller 242, while providing horizontal synchronization signals (HSYNC signals) for each line of video signal.

The formed image is developed by the high-voltage unit 249 in the developer 238 with AC high-voltage Vac being additionally applied for development, the latent image is formed on the uniformly charged photosensitive drum 215, and then a visible image or toner image is produced by developing this latent image. The engine controller 243 controls that transfer unit 240 transfers to the image onto paper under a high-voltage for image transfer. The toner image is fixed by the fixer unit 228, while the paper transport mechanism 246 sends paper fixed toner image to the output port specified in the print condition. The video controller 242 has such functions that displays the printer 201 status on the control panel 250 and recognizes the commands provided by the user. The engine controller 243 reads various sensor signals via the sensor input 247 and detects the presence/absence of paper on the transport paths.

In the fourth embodiment, the engine controller 243 controls to operate selectively of the first-fourth controllers 243i and paper-feed-delay controller 243j, based on the conditions stored in the reservation memory table 243g. In the paper transport mechanism 246, the rotation of the photosensitive drum 215 is provided by a motor shared with the paper feeder rollers 203, 204, 206, 207, 209, 211, 212 and 214. The photosensitive drum 215 is directly connected with this motor, while those paper feeder rollers are connected with the motor as a state of transmission via a clutch.

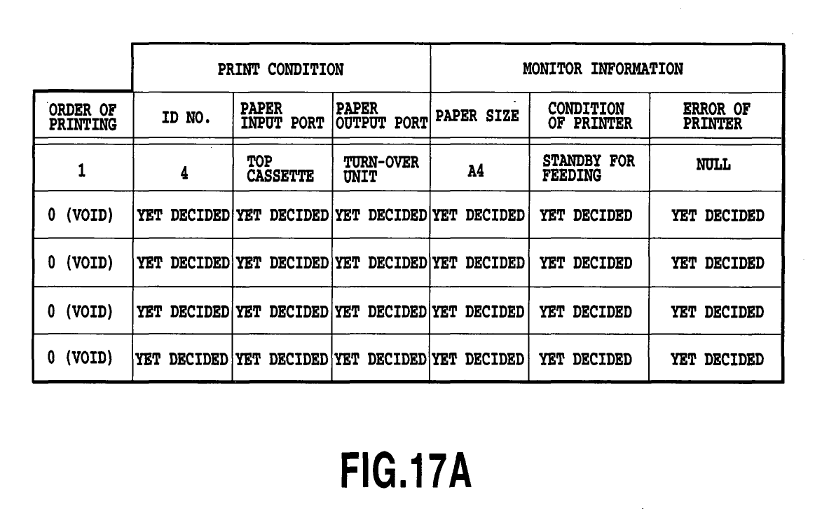

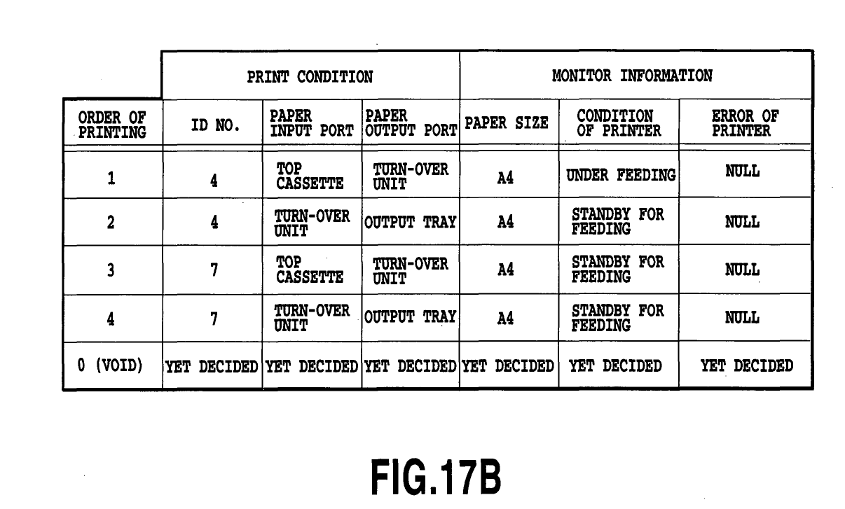

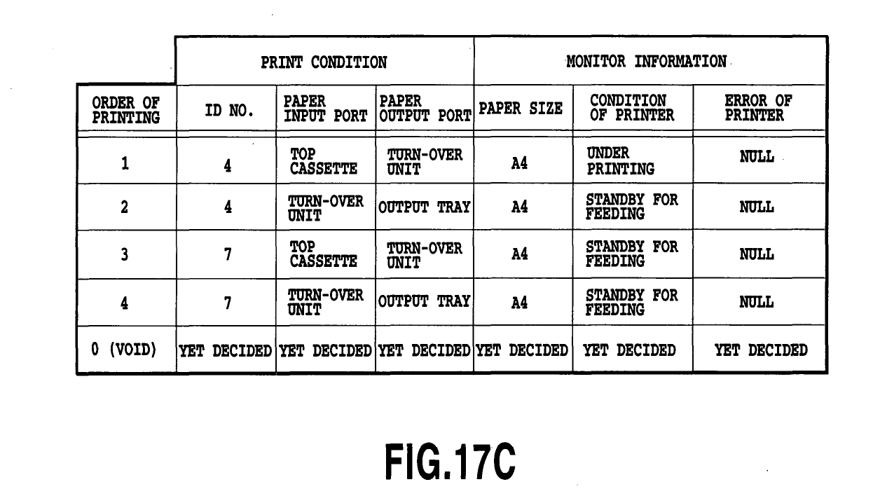

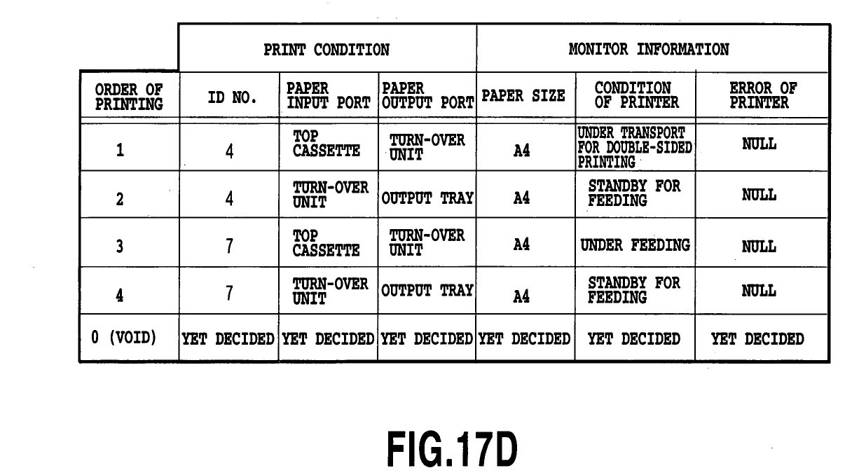

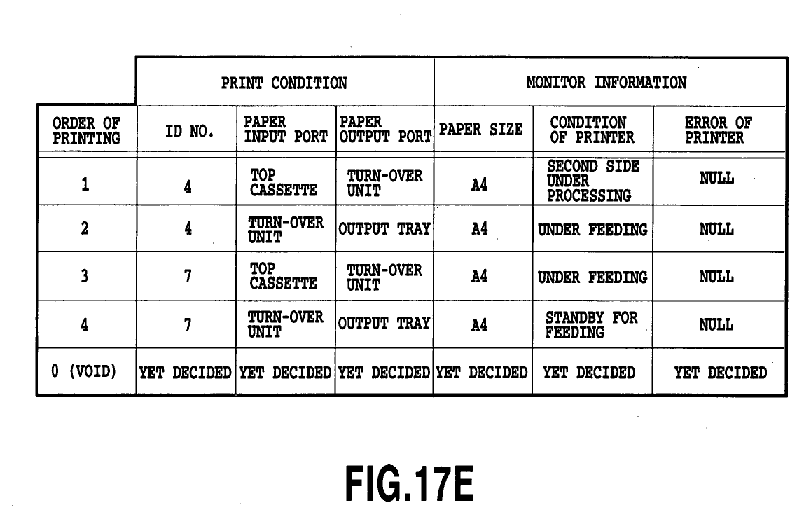

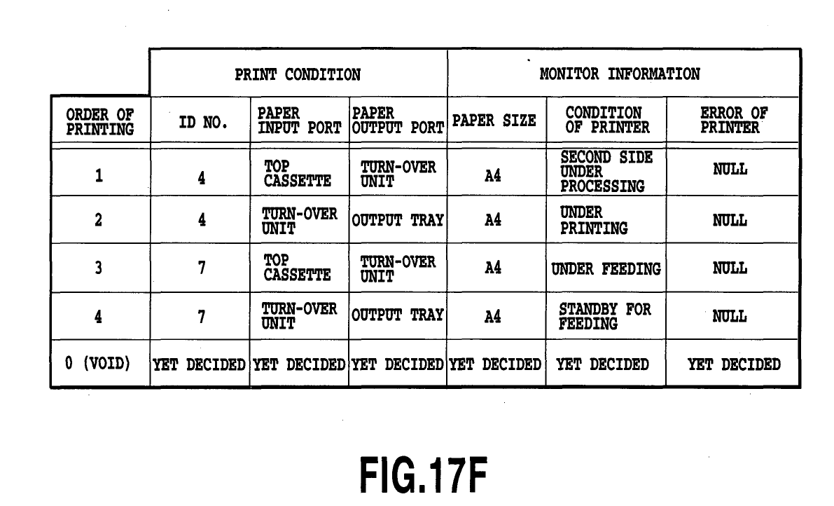

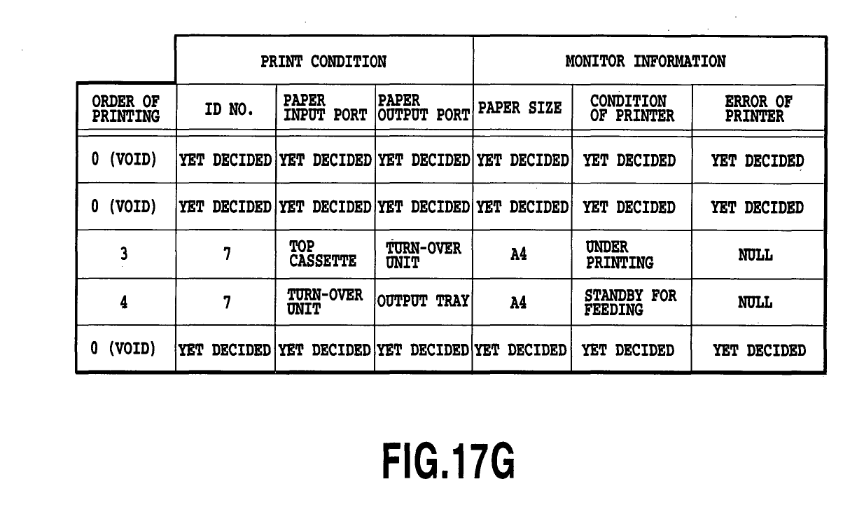

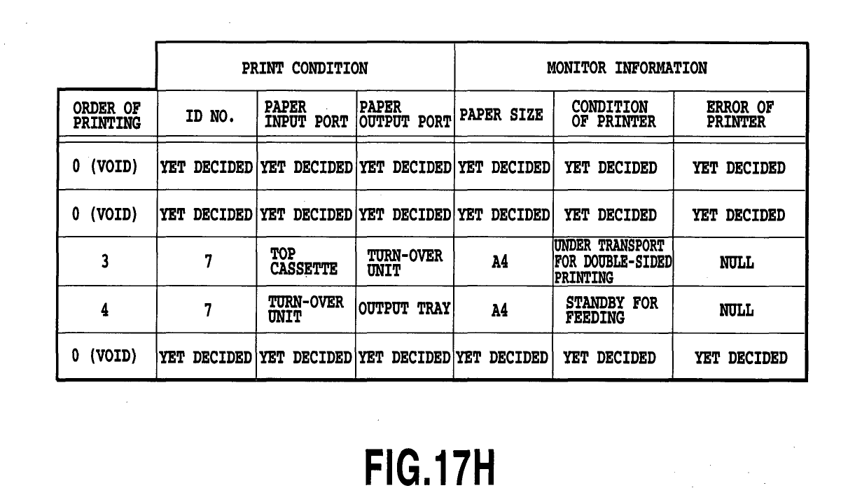

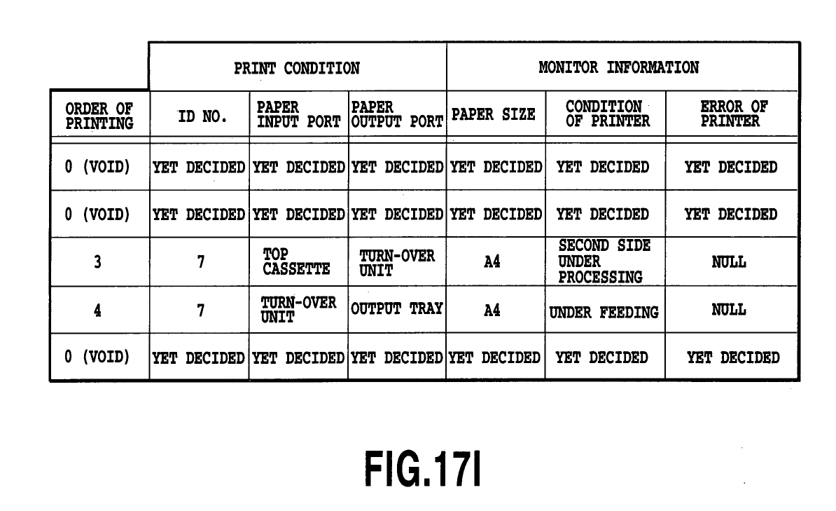

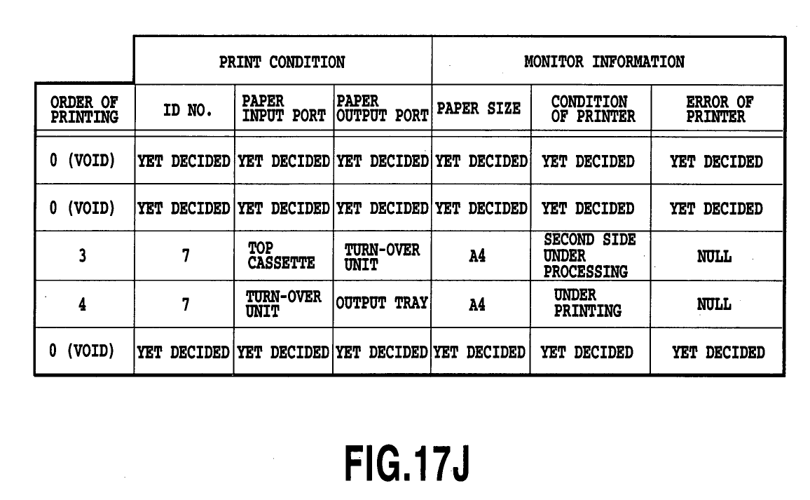

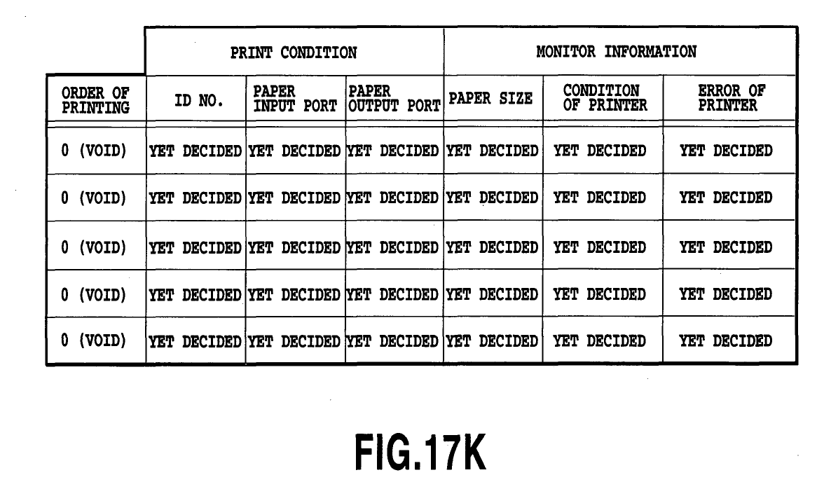

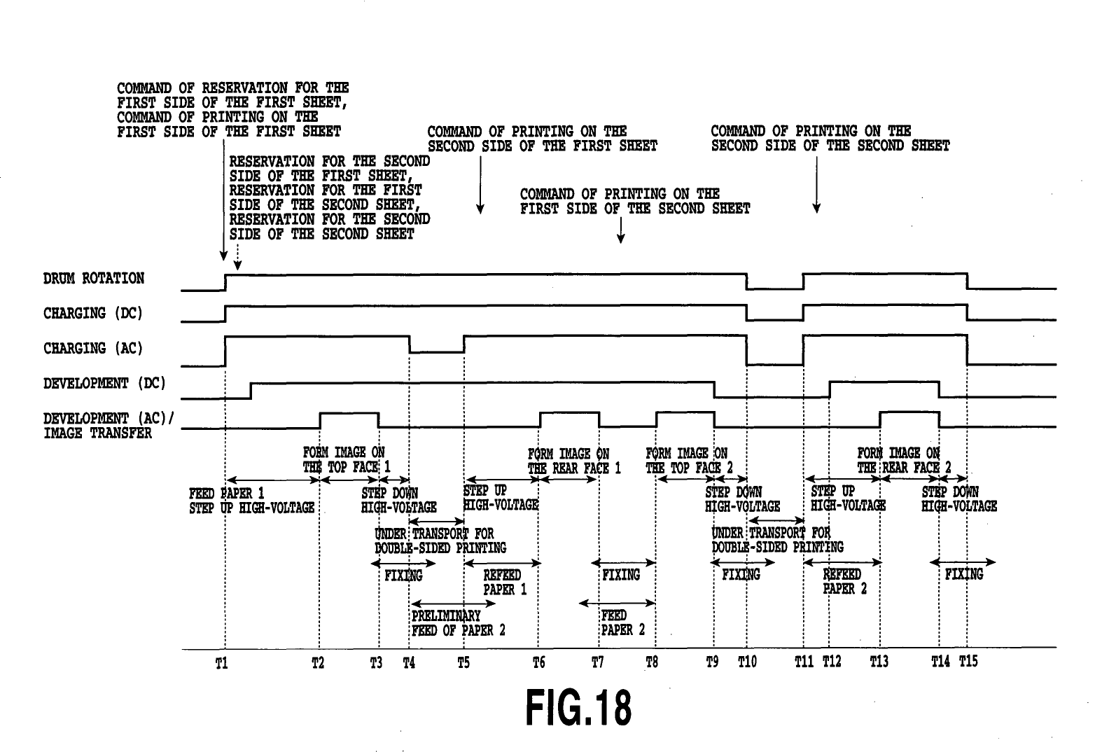

FIGS. 17A-17K are data of print reservation tables for the image forming apparatus of the fourth embodiment, and FIG. 18 is a time chart for printing in the image forming apparatus of the fourth embodiment. Now the sequence of print reservation and printing operation is explained with reference to these figures.

It is assumed in FIGS. 17A-18 that two sheets of paper in the top cassette 202 in FIG. 14 are double-sided printed and dropped to the output tray 221. Double-sided printing is conducted on one sheet at a time by turning over the sheet, in the order of a first side of the first sheet, the other side of the first sheet, a first side of the second sheet and the other side of the second sheet. The top cassette has A4 size sheets of paper at least two. When the video controller 242 has translated image data into bit data for a first side of the first sheet of recording paper P, it provides to the engine controller 243 an ID for the first side of the first sheet and provides commands for print reservation and printing meeting the print condition (ID=4, feeder port=top, output port=turn-over unit) via a serial interface (I/F) as shown FIG. 17A.

The engine controller 243 received print reservation and print signal from the video controller 242 saves the print conditions (ID, feeder port and output port) and the reserved paper size in the print reservation tale 243g following the reservation sequence, based on the print reservation made by the video controller 242. The top cassette 202 automatically detects the paper size as the A4 size and registers it as the regular A4 size. As a state of operation, because no paper has been fed yet, a paper-feed standby state is registered, while no error is registered. As a result, as shown in FIG. 17A, the print reservation information for a first side of the first sheet of recording paper P is registered in the print reservation table.

The video controller 242 provides print reservation commands corresponding to the print conditions for the second side of the first sheet (ID=4, feeder port=turn-over unit, output port=output tray), for the first side of the second sheet (ID=7, feeder port=top cassette, output port=turn-over unit) and for the second side of the second sheet (ID=7, feeder port=turn-over unit, output port=output tray). The engine controller 243 received print reservation signal from the video controller 242 registers a paper-feed standby state with no error because no paper feeding is initiated (as shown FIG. 17B) Now the engine controller 243 starts printing operation on the sheet of ID=4 (first sheet).

First, the engine controller 243 starts that the scanner motor 232a is activated to start the scanner; polygon mirror 232b is activated constant rotation; the photosensitive drum 215 is activated under high-voltage (DC high-voltage Vdc is provided for development after the charging DC high-voltage Vcdc and the charging AC high-voltage Vcac have been applied); and paper feeding is initiated for the paper of ID=4 of the first print condition. Then as shown in FIG. 17B, the status of the first side of the first sheet of ID=4 is changed during paper feeding.

Now that the engine controller 243 has fed paper after tip of recording paper P is transport to resist roller 214 and the video controller 242 has issued an command of printing, image formation is initiated under exchange of vertical synchronization signals (VSREQ signal and VSYNC signal): specifically, the exposure unit conducts exposure; the developer activated by DC voltage develops the image; and the transfer unit 240 activated by high-voltage conducts toner image on the photosensitive drum 215 to recording paper P. Then as shown in FIG. 17C, the status of ID=4 for the first side of the first sheet is updated to “under printing”.

When the engine controller 243 has completed image formation for first side of the first sheet, the photosensitive drum 215 is kept rotating but the output of charging AC high-voltage Vcac is lowered. The toner image is fixed, and the paper sheet is turned over and sent to the double-sided printing unit to wait for re-feeding. During this process, the feeder rollers 203, 204 are coupled with the motor by the clutch to conduct preliminary feeding of the recording paper P of ID=7 (first side of the second sheet). Namely, the paper is transported from the top cassette 202 to the upstream of the feeder sensor 208 not to be nipped by the re-feeder rollers 209 for standby. As shown in FIG. 17D, the status of ID=4 for the first side of the first sheet is changed to “under transport for double-sided printing” and the status of ID=7 for the first side of the second sheet is changed to “under feeding”.

When the first side of the first sheet has reached the position for re-feeding, the engine controller 243 restores the charging AC high-voltage Vcdc output for charging and re-feeds the paper for printing on the second side of the first sheet. During this process, the video controller 242 translates the image bit data for the second side of the first sheet and then gives to the engine controller 243 a command of printing on the second side of the first sheet. As shown in FIG. 17E, the status of ID=4 for the second side of the first sheet is changed to “under feeding”, while the status of the first sheet is changed to “second side under processing” because the printing on the second side is underway as shown in FIG. 17E.

Now that the engine controller 243 has completed paper re-feeding and the video controller 242 has issued a command of printing, image formation is initiated under exchange of vertical synchronization signals (VSREQ signal and VSYNC signal). At the same time, as shown in FIG. 17F, the status of ID=4 for the second side of the first sheet is updated to “under printing”.

The engine controller 243 resumes the feeding of the second sheet for printing on its first side, and the image formation on the second side of the first sheet is completed and the toner is fixed. The engine controller 243 controls that the video controller 242 issues a command of printing on the first side of the second sheet, and the image formation on the first side of the second sheet is initiated. As shown in FIG. 17G, when the first sheet is sent out, the status of ID=4 for the first and second sides of the first sheet is deleted, while the status of the first side of the second sheet related to printer 201 is updated to “under printing”.

When the image formation on the first side of the second sheet is completed, the engine controller 243 steps down high-voltage (steps down DC high-voltage Vdc for development and high-voltage for image transfer, and then terminates both charging DC high-voltage Vcdc and charging AC high-voltage Vcac), and stops the rotation of the photosensitive drum 215. In this example, because there is no subsequent print reservation after printing on the second side of the second sheet, no preliminary feeding is necessary. Thus there is no need to activate the feeder roller 203, and the photosensitive drum 215 can be deactivated. The toner image is fixed, and the paper sheet is turned over by turn-over unit 260 and sent to the double-sided printing unit 261 for re-feeding. As shown in FIG. 17H, the status of ID=7 for the first side of the second sheet is updated to “under transport for double-sided printing”.

When the second sheet has been sent to the position for re-feeding for printing on the second side, the engine controller 243 resumes the rotation of the photosensitive drum 215 and steps up high-voltage unit 249 (provides charging DC high-voltage Vcdc and charging AC high-voltage Vcac and then provides DC high-voltage Vdc for development), and re-feeds the second sheet for printing on its second side. As shown in FIG. 17I, the status of ID=7 for the second side of the second sheet is updated to “under feeding”, and the status of the second sheet is changed to “second side under processing” because the printing operation has moved to the second side from the first side of the second sheet.

After the image data is translated to bit data for printing on the second side of the second sheet, the video controller 242 issues to the engine controller 243 a command of printing on the second side of the second sheet. Now that the engine controller 243 has completed paper re-feeding and the video controller 242 has issued an command of printing, image formation is initiated under exchange of vertical synchronization signals (VSREQ signal and VSYNC signal). At the same time, as shown in FIG. 17J, the status of ID=7 for the second side of the second sheet is updated to “under printing”.

When image formation is completed, the engine controller 243 steps down high-voltage unit 249 (steps down high-voltage Vdc for development and for image transfer, and then terminates both charging DC high-voltage Vcdc and charging AC high-voltage Vcac), and suspends the rotation of the photosensitive drum 215. The scanner motor is also deactivated. As shown in FIG. 17K, when the second sheet is sent out from printer 210 to output tray 221 after printing on its second side is over, the status of ID=7 for the first and second sides of the second sheet is deleted, and now there is no print reservation.

As indicated in the time chart for printing shown in FIG. 18, that two sheets of paper in the top cassette 202 are double-sided printed and dropped to the output tray 221, along with the start of photosensitive drum 215 rotation (T1), charging AC high-voltage Vcac and charging DC high-voltage Vcdc are provided for step up high-voltage unit 249, and then DC high-voltage Vcdc for development is stepped up (T1), and paper feeding is initiated. After paper feeding is completed, an image is formed (T2-T3) on the first side of the first sheet (AC high-voltage Vac for development and high-voltage for image transfer are provided during image information), the toner image is fixed, the output of charging AC high-voltage Vcac is lowered (T3-T4), and preliminary feeding is initiated for printing on the first side of the second sheet (T4).

After image fixing on the first side of the first sheet, the paper is turned over and sent to the position for re-feeding. When the first sheet is sent to the position for re-feeding, the AC high-voltage Vcac for the charger is stepped-up (T5-T6) and the first paper is re-fed for printing on its second side. After the step-up of high-voltage Vcac and completion of paper re-feeding, image formation on the second side of the first sheet is initiated (T6). Then the second sheet (T8) is fed again for printing on its first side, while the image formed on the second side of the first sheet is affixed. After the completion of feeding of the second sheet, image formation is started. After an image is formed on the first side of the second sheet and the image is affixed, high-voltage of high-voltage unit 249 is stepped down (terminates DC high-voltages Vdc for development and image transfer, and then terminates both charging AC high-voltage Vcac and charging DC high-voltage Vcdc), and the photosensitive drum 215 rotation is suspended (T10).

When the image on the first side of the second sheet is affixed and the second sheet has been sent to the position for re-feeding for printing on its second side (after turned over and sent to the position for re-feeding, the rotation of the photosensitive drum 215 is resumed (T11) and high-voltage of high-voltage unit 249 are stepped up (charging DC high-voltage Vcdc and charging AC high-voltage Vcac are stepped up and then DC voltage Vdc for development is stepped up), and the second sheet is re-fed for printing on its second side (T11). After the step-up of high-voltage of high-voltage unit 249 and completion of paper re-feeding (T12), an image is formed on the second side of the second sheet. After image formation on the second side of the second sheet (T12-T13), the high-voltage of high-voltage unit 249 are stepped down (terminate high-voltages for development and image transfer, and terminate both charging AC high-voltage Vcac and charging DC high-voltage Vcdc), and the photosensitive drum 215 rotation is stopped. The image is affixed, and the paper is ejected.

As described here, the highest throughput the printer 201 can achieve is attained with no cost-up by the preliminary feeding of the subsequent recording paper (second sheet) while the first sheet P is turned over and transported to the position for double-sided printing during the time between the moment image formation on the first side of the first sheet P is completed and the moment of printing on the second side of the first sheet.

If the rotation of the photosensitive drum 215 is suspended during paper transport in the turn-over unit and the high-voltage unit 249 is deactivated, it is possible to prevent that charging AC high-voltage Vcac gives negative impact on the useful life of the photosensitive drum 215. In the printer 201 of the fourth embodiment, however, the driving source for the photosensitive drum 215 shares the same motor with that for the feeder roller that conducts preliminary paper feeding during paper transport in the turn-over unit. In this type printer 201, the feeder roller must be kept activated for preliminary paper feeding during paper transport in the turn-over unit, and thus the photosensitive drum 215 sharing the same driving source with this roller cannot be stopped. Then it becomes possible to reduce wear of the photosensitive drum 215 while conducting preliminary paper feeding, by lowering the output of charging AC high-voltage Vcac during paper transport in the turn-over unit.

When the output of charging AC high-voltage Vcac is lowered, if the potential Vd of the photosensitive drum 215 for charging, which is the sum of charging DC high-voltage Vcdc and the lowered charging AC high-voltage Vcac, is set at a value higher than the DC high-voltage Vdc for development (AC high-voltage Vac is absence), unnecessary pick-up of toner is preferably prevented, and stains and waste of toner can be prevented. Because the interval between printing on the second side of the first sheet and that on the first side of the second sheet is a regular transport interval time Tr, the output to the charger is not changed. There is no need to conduct preliminary paper feeding in the interval between printing on the first side and on the second side of the second sheet during the time while the first sheet is turned over and sent to the position for re-feeding, because there is no reservation of subsequent printing.

Then it is possible to further reduce wear of the photosensitive drum by terminating the output of both charging DC high-voltage Vcdc and charging AC high-voltage Vcac and by suspending rotation of the photosensitive drum 215 during this period of time. After the image is formed on the second side of the second sheet, there is no subsequent printing. Thus, both charging AC high-voltage Vcac and charging DC high-voltage Vcdc are immediately turned off, and the rotation of the photosensitive drum 215 is suspended to reduce wear of the drum. In this embodiment, the timing of restoring the output of which AC voltage for charging has been lowered during paper transport in the turn-over unit is the timing of re-feeding. The photosensitive drum 215 turns once after the high-voltage has been restored, so that the surface of the photosensitive drum 215 is uniformly charged before exposure.

Similarly, the timing of resuming the terminated output of dc and AC voltages for charging is the timing of re-feeding. The photosensitive drum 215 turns once after the high-voltage has been restored, so that the surface potential Vd of the photosensitive drum 215 is uniformly charged before exposure.

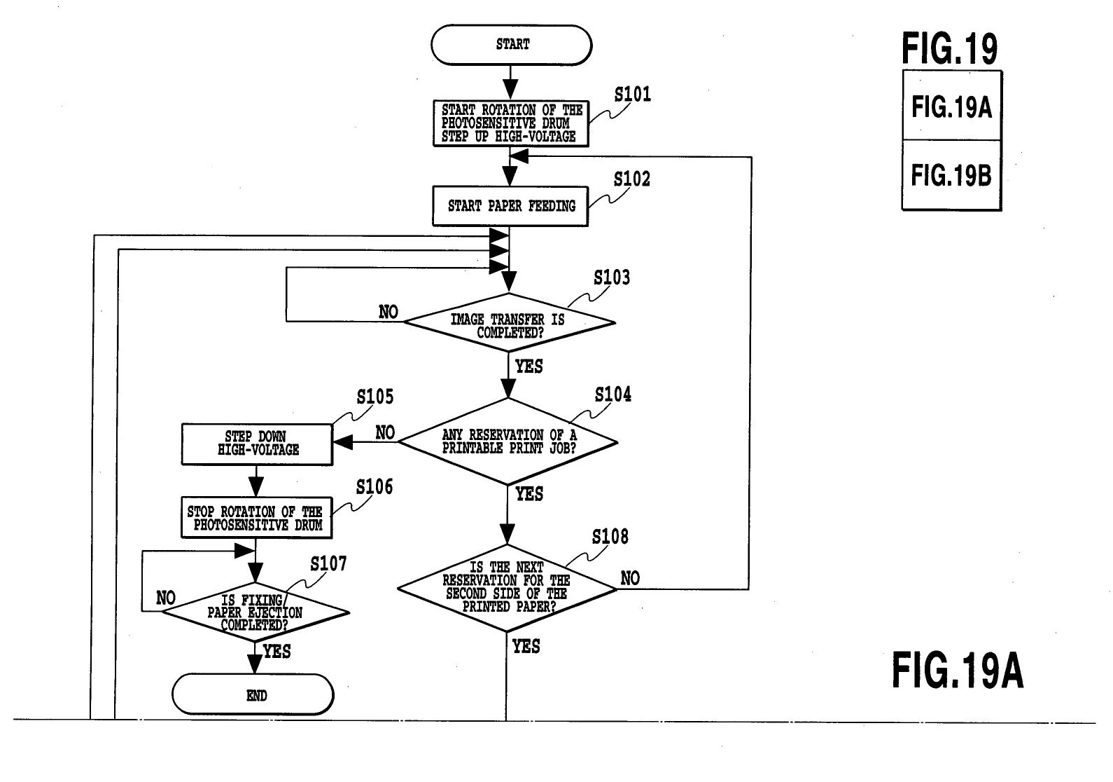

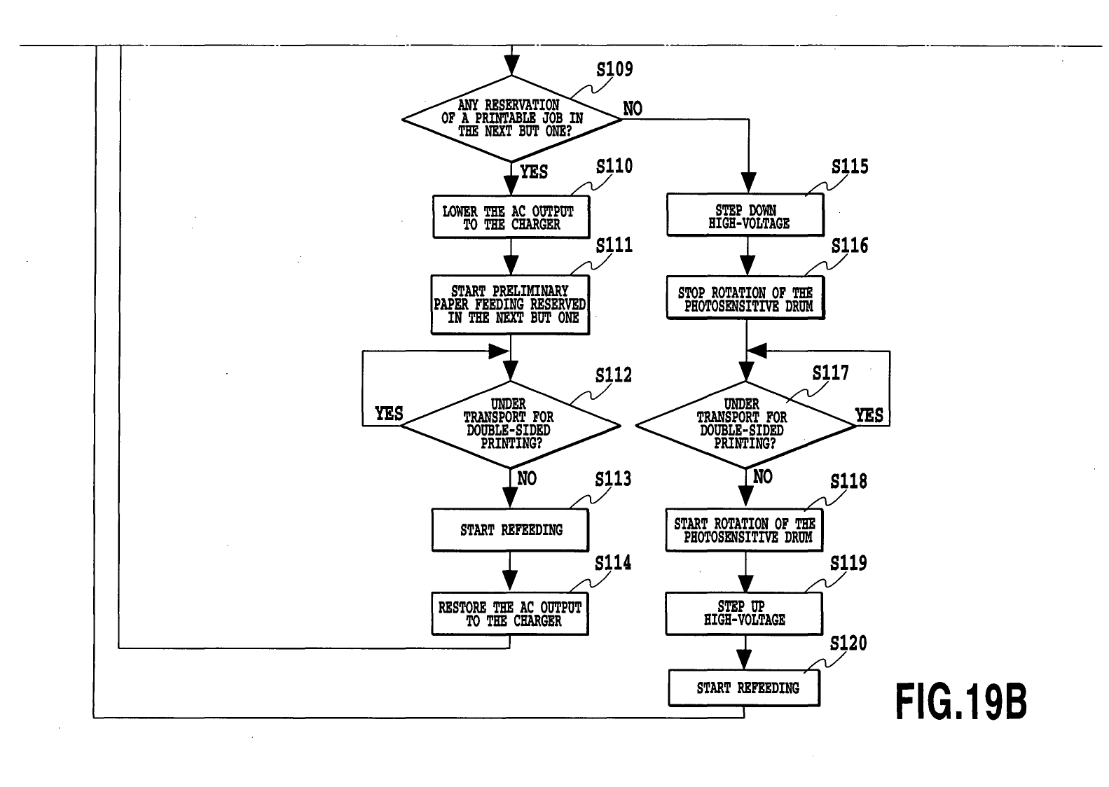

FIGS. 19A and 19B are a flowchart illustrating the steps of printing operation in the engine controller 243 of the image forming apparatus of the first embodiment. This flowchart focuses on the steps of paper feeding and image formation. Printing operation is initiated by the commands of print reservation and printing received from video controller 242 that enable printing operation.

First, the engine controller 243 controls that the photosensitive drum 215 and high-voltage unit 249 are activated (both charging AC high-voltage vcac and charging DC high-voltage Vcdc are provided and then the DC high-voltage Vdc for development is provided) (step S101). Paper feeding is started (step S102) and image transfer (image formation) is completed (step S103). During image formation, the AC high-voltage Vac for development and high-voltage for image transfer are provided. After image transfer is over, it is checked whether any printable subsequent print reservation exists or not (step S104). Unless there is any printable print reservation, the high-voltages are stepped down (by terminating the high-voltages for development and for image transfer, and then terminating both charging AC high-voltage Vcac and charging DC high-voltage Vcdc) (step S105), and the rotation of the photosensitive drum is ceased (step S106). After image fixing and paper ejection (step S107), the printing operation is over.

If there is any printable print reservation even after image transfer, it is checked whether the next reservation is that for printing on the second side of the sheet of which printing has been ended (step S108). If not so, the process returns to step S102 to conduct printing for the subsequent reservation. If so, it is checked whether the next but one printable print reservation exists or not (step S109).

If exists, the output of AC voltage for charging is lowered (step S110), and the preliminary paper feeding is conducted for printing reserved in the next but one (step S111). Then the first sheet is affixed, turned over, and transported to the position for re-feeding (step S112). When such transport is completed, the paper sent to the position for re-feeding is re-fed for printing on the other side (step S113), and the output of charging AC high-voltage Vcac is restored (step S114). Then an image is formed on the second side, and the process returns to step S103.

On the other hand, unless there is the next but one printable print reservation at step S109, the high-voltages are stepped down (by terminating the output of high-voltages for development and image transfer) (step S115), and the rotation of the photosensitive drum is ceased (step S116). The image on the first side is fixed, the paper is turned over and transported to the position for re-feeding (step S117).

When such transport is completed, the rotation of the photosensitive drum 215 is resumed (step S118), the high-voltages are stepped up (by providing both charging AC high-voltage Vcac and charging DC high-voltage Vcdc and then providing DC high-voltage Vdc for development) (step S119), and the paper sent to the position for re-feeding is re-fed for printing on its second side (step S120). Then an image is formed on the second side, and the process returns to step S103.

As explained above, throughput has been maximized with no rise in cost by the preliminary feeding of the second sheet in the print interval between printing on the first side of the first sheet and on the second side of the first sheet, specifically during the period while the first sheet is turned over and sent to the position for re-feeding for printing on the other side. However, the feeder roller must be rotated for the preliminary paper feeding during paper transport in the turn-over unit 260, and it is therefore impossible to deactivate the photosensitive drum 215 that shares the same driving source with the feeder roller. Thus, during this period of time, the output of AC voltage for charging is lowered, so as to reduce wear of the photosensitive drum 215 while conducting preliminary paper feeding. In fact, compared with the time of no decrease in the output of AC voltage for charging during the regular paper interval, the wear of the drum is reduced by 30% when the output of AC voltage for charging is lowered.

Since the interval between printing on the second side of the first sheet and that on the first side of the second sheet is a regular paper interval, the output to the charger is not changed. There is no need to conduct preliminary paper feeding in the interval between printing on the first side and on the second side of the second sheet, because there is no reservation of subsequent printing during the time the first sheet is turned over and sent to the position for re-feeding. Then it is possible to further reduce wear of the photosensitive drum 215 by terminating the output of both charging DC high-voltage Vcdc and charging AC high-voltage Vcac and by suspending the rotation of the photosensitive drum 215 during this period of time.

The photosensitive drum 215 does not wear when it is not rotating or high-voltage is not applied. After image formation on the second side of the second sheet, there is no subsequent print to be done. Thus, both charging AC high-voltage Vcac and charging DC high-voltage Vcdc are immediately turned off, and the rotation of the photosensitive drum 215 is terminated to reduce wear of the drum. As a result, it becomes possible to prevent the photosensitive drum 215 from wearing in the optimized manner for double-sided printing, while maintaining throughput at the maximum with no rise in cost.

Moreover, it is more preferable to store data on the degree of photosensitive drum 215 wear and remaining life of the photosensitive drum 215 in nonvolatile memory (whether contact type or non-contact type using an antenna) because the photosensitive drum 215 can be used over its full life that has been prolonged by the invention. Such data is provided, as disclosed in Japanese Patent Application Laid-open No.10-039691, by considering the rate of wear based on the rotation time of the photosensitive drum 215, the regular time of output of charging AC high-voltage Vcac and the time of lowered output of the AC voltage.

[Embodiment 5]

FIG. 14 is a structure of the image forming apparatus of a fifth embodiment of the present invention. FIGS. 15 and 16 are block diagrams illustrating the functions of the image forming apparatus of the fifth embodiment. Because they are the same as those of the fourth embodiment, their explanation is not repeated.

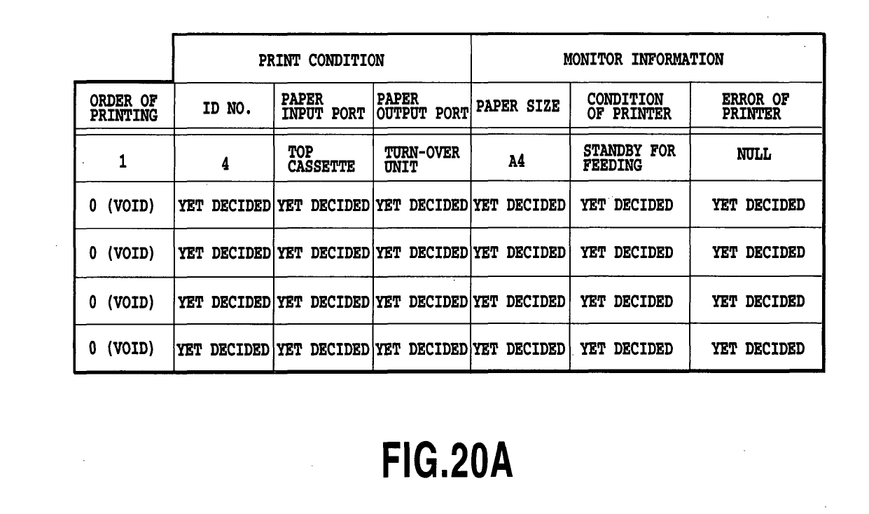

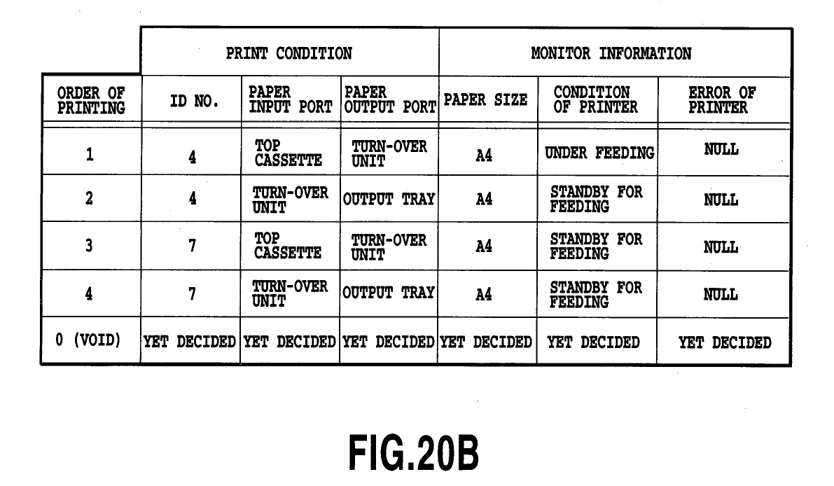

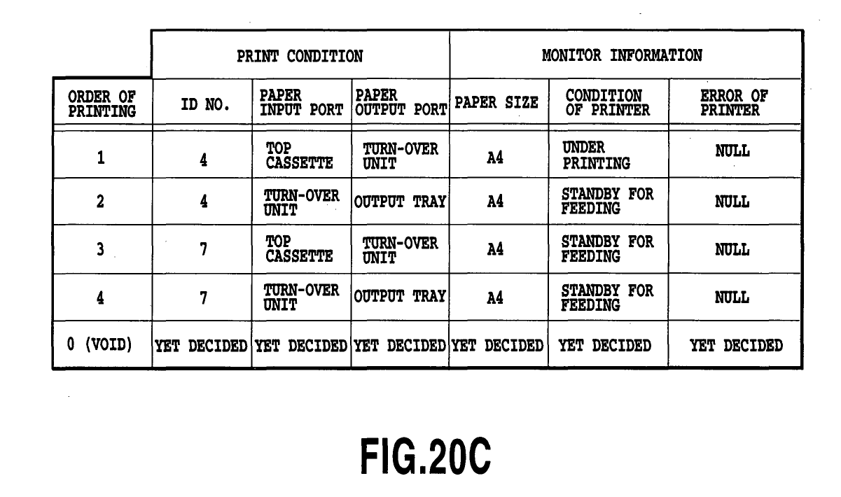

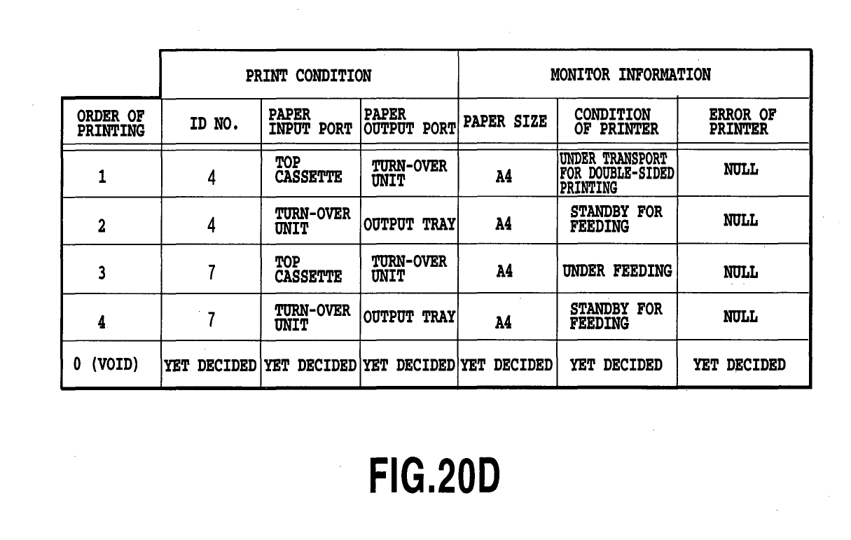

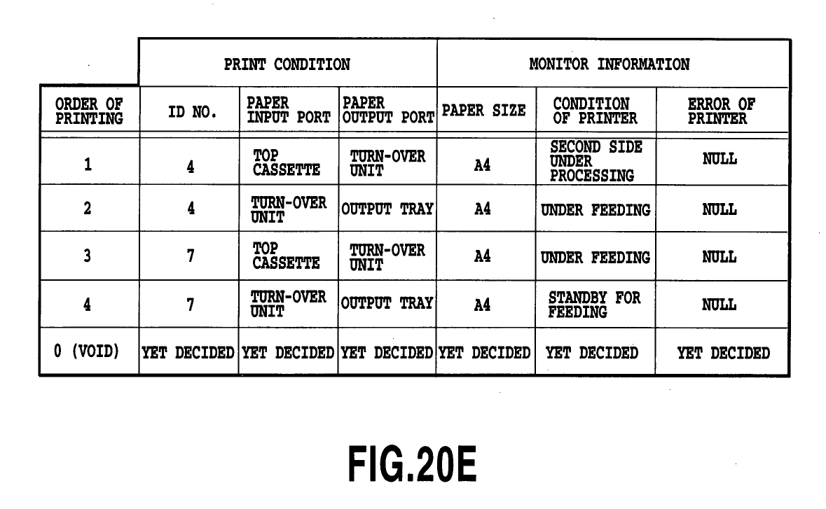

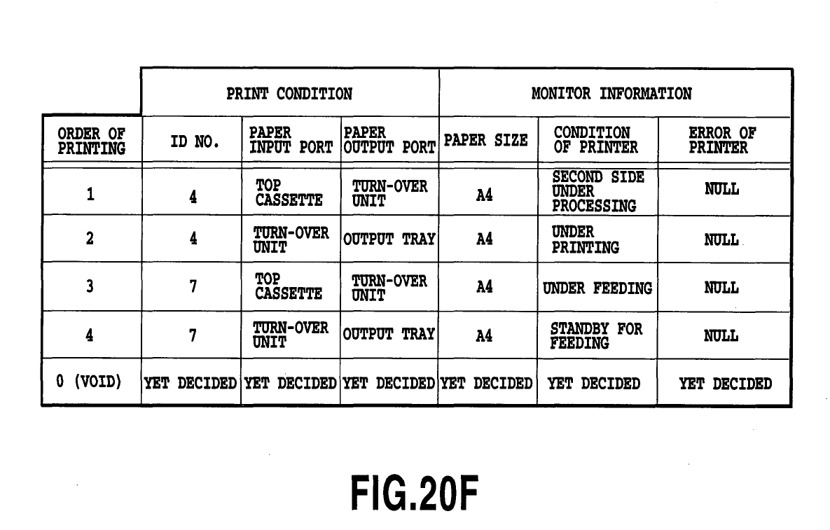

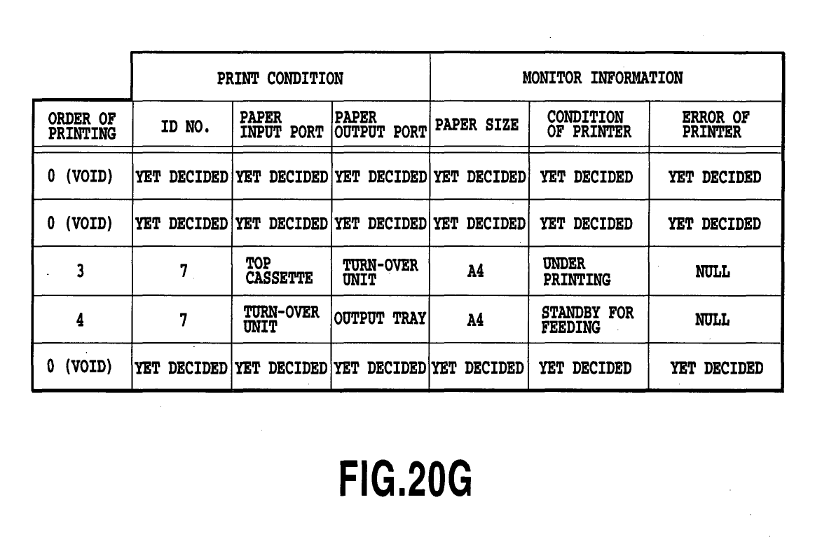

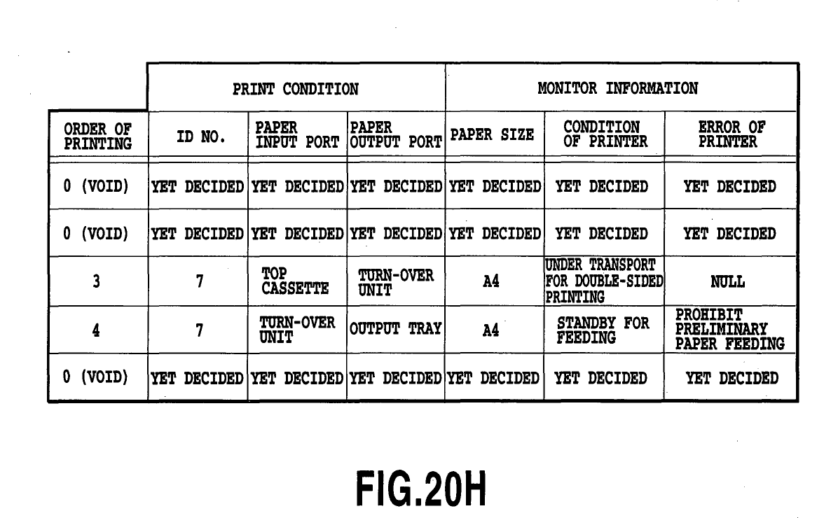

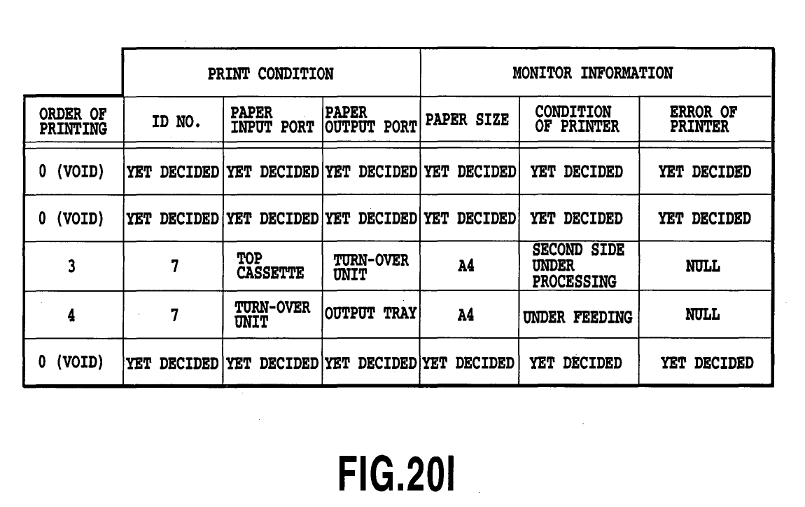

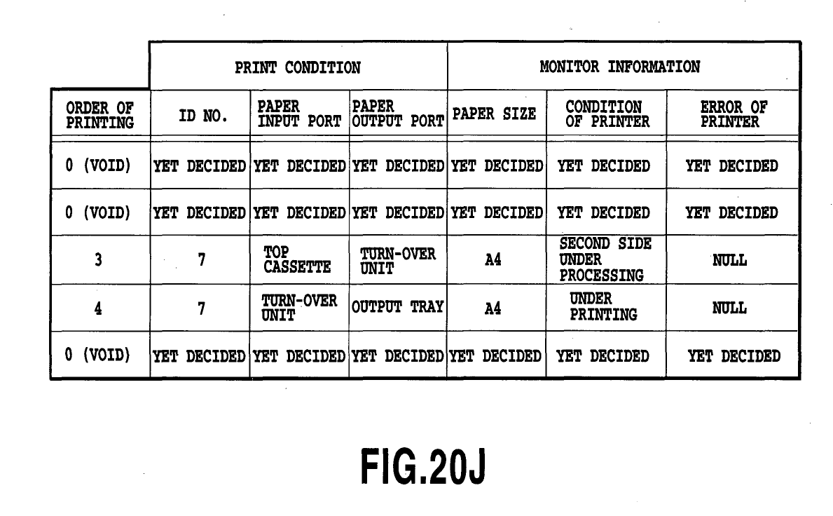

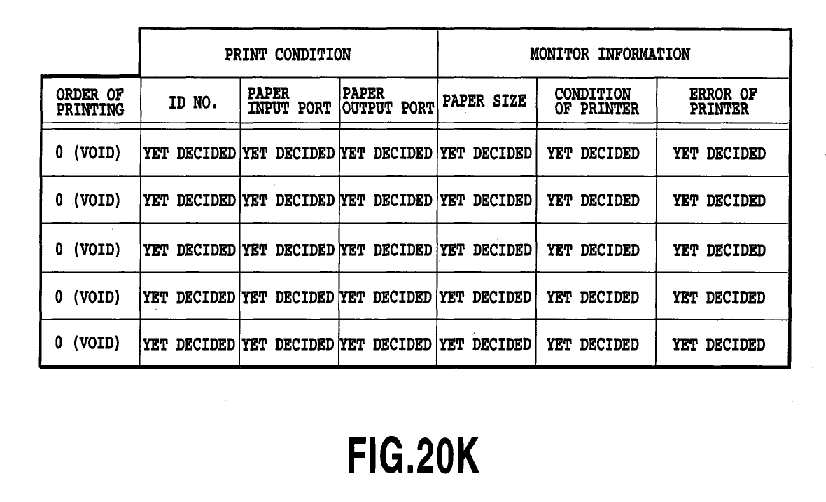

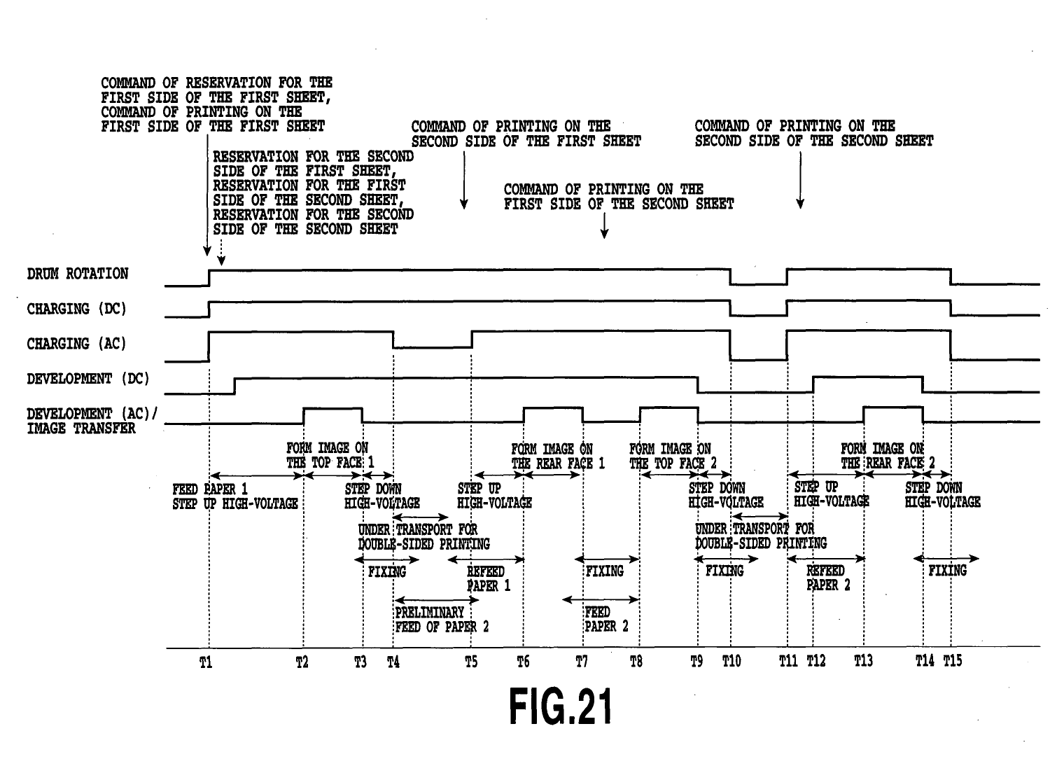

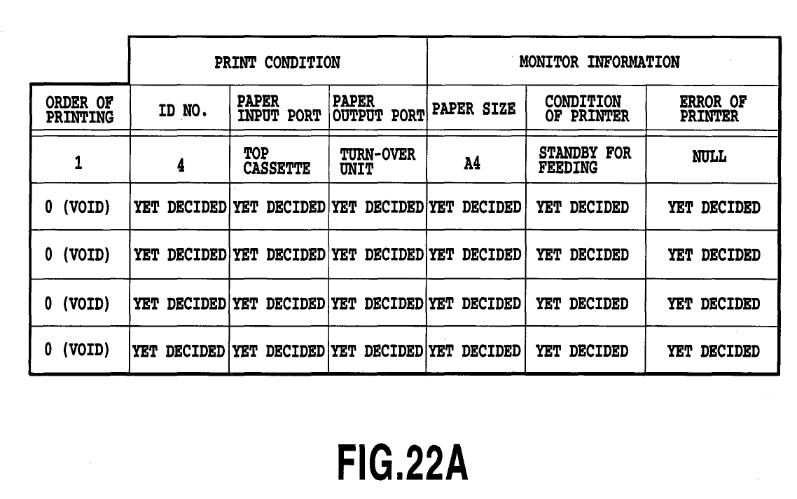

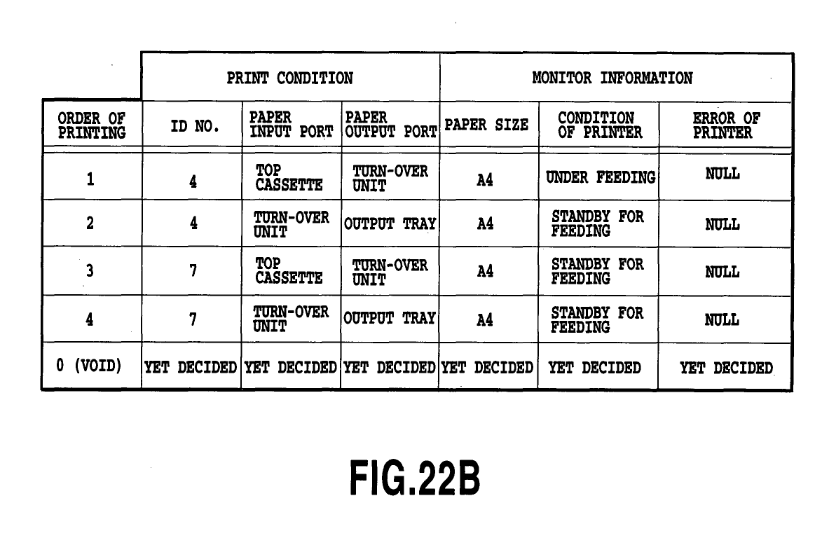

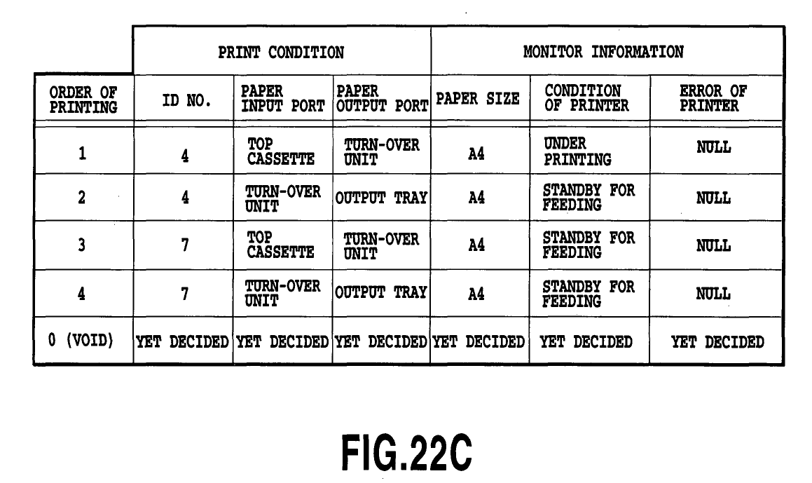

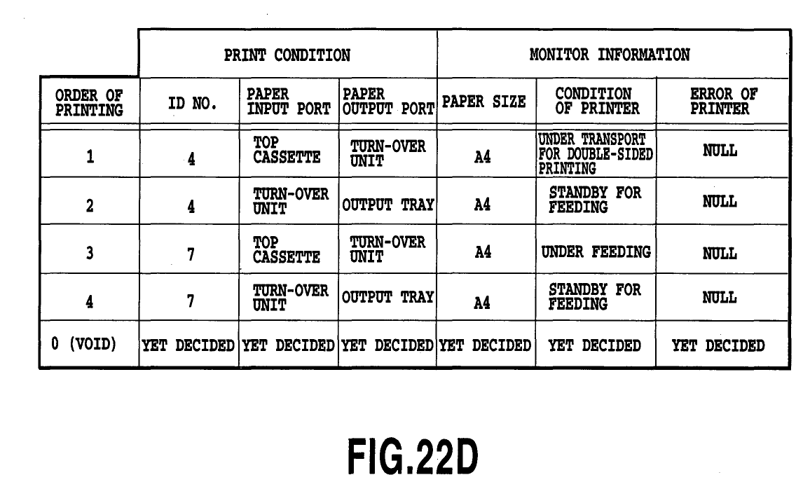

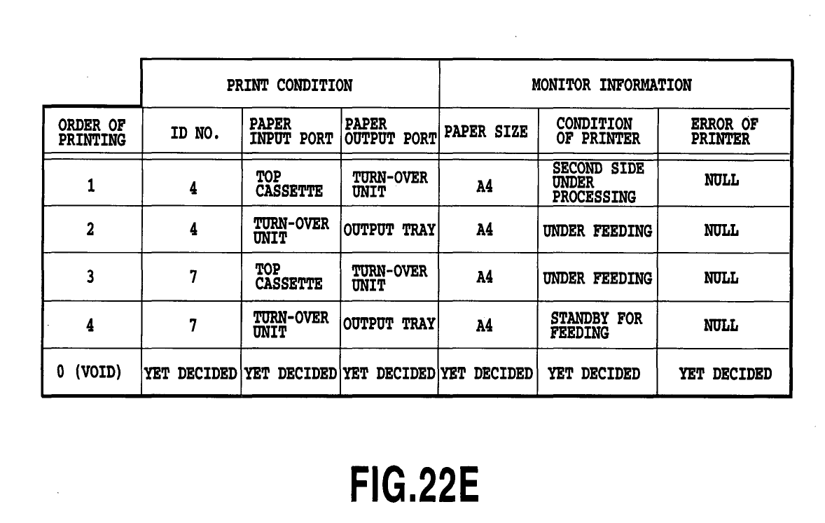

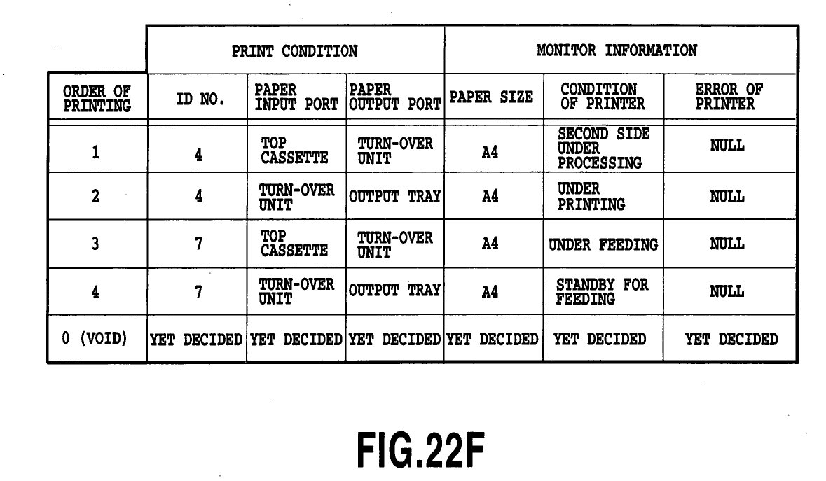

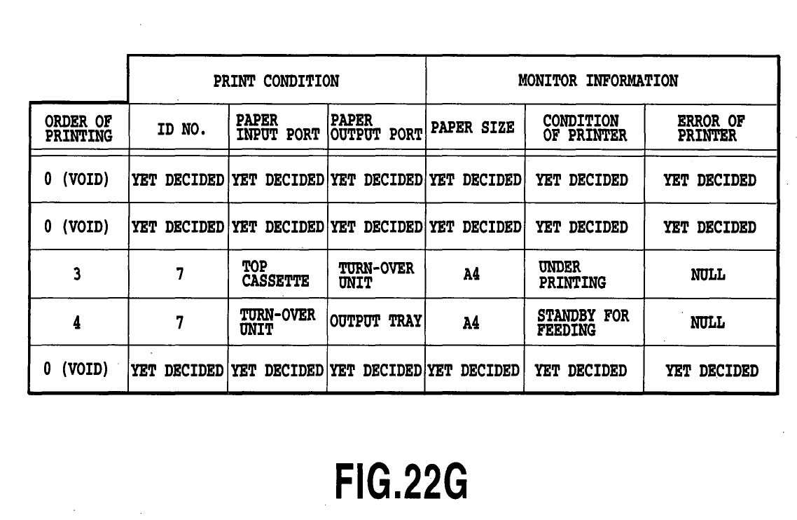

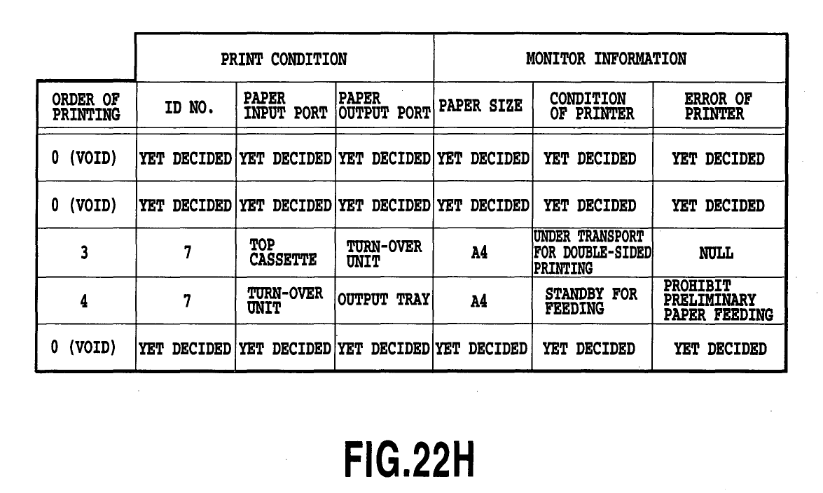

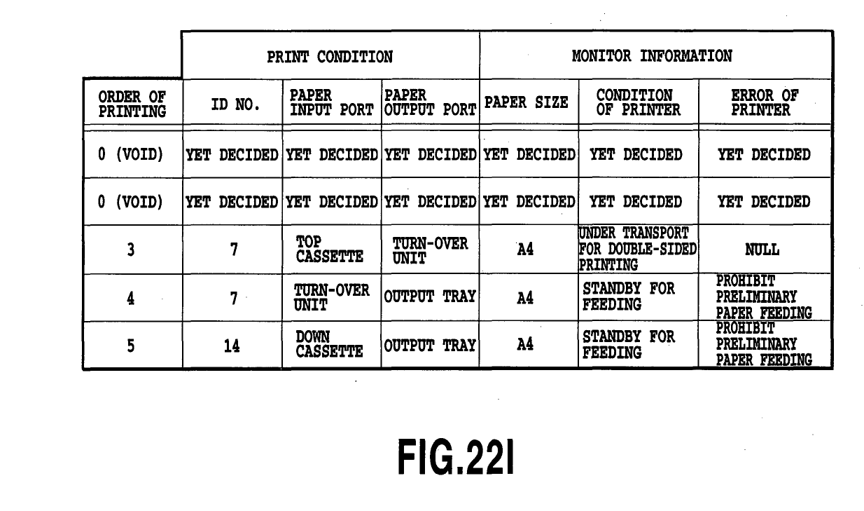

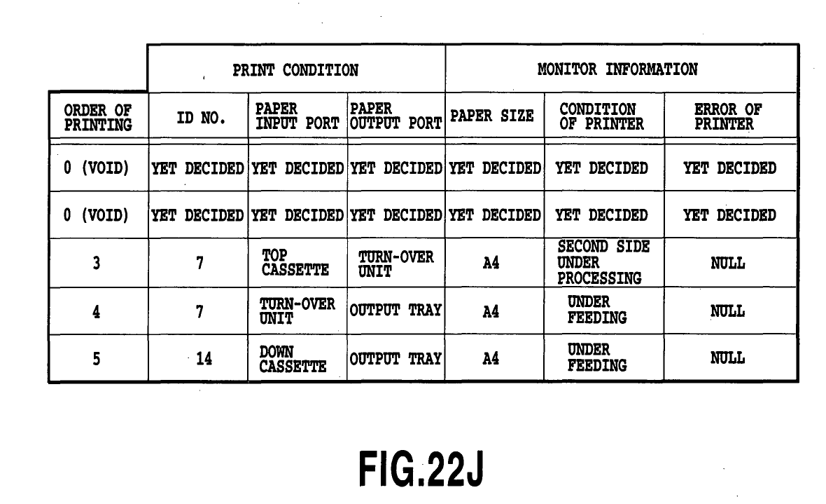

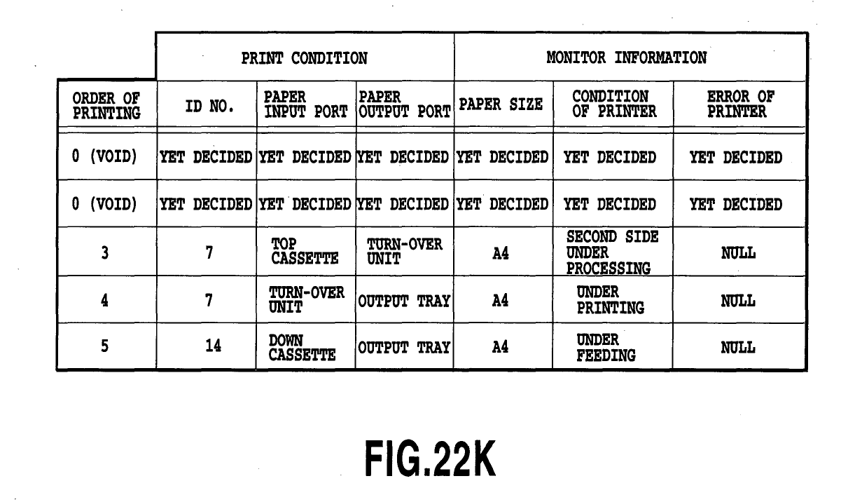

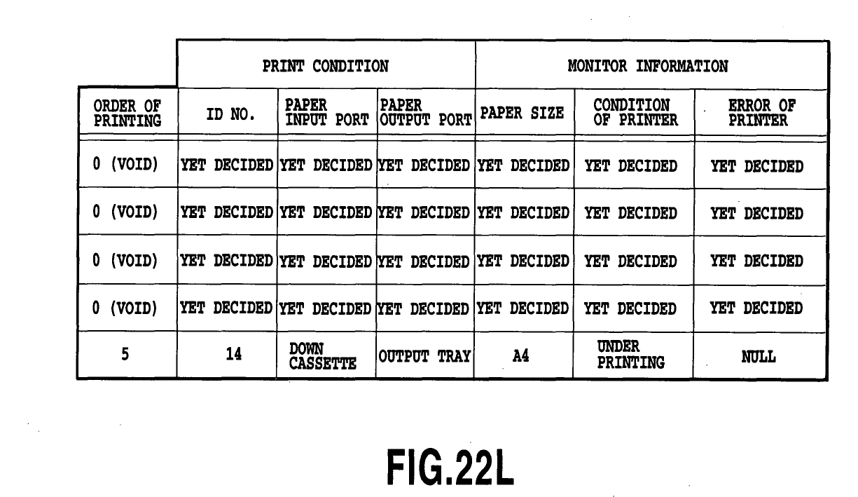

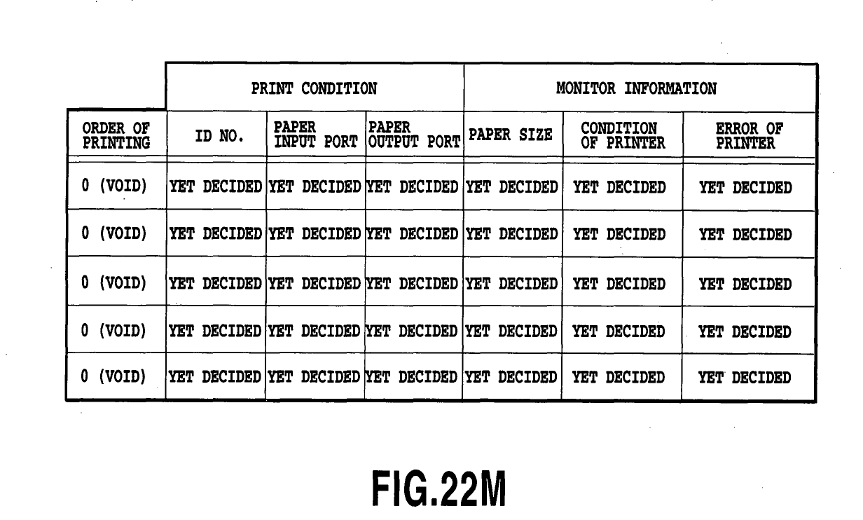

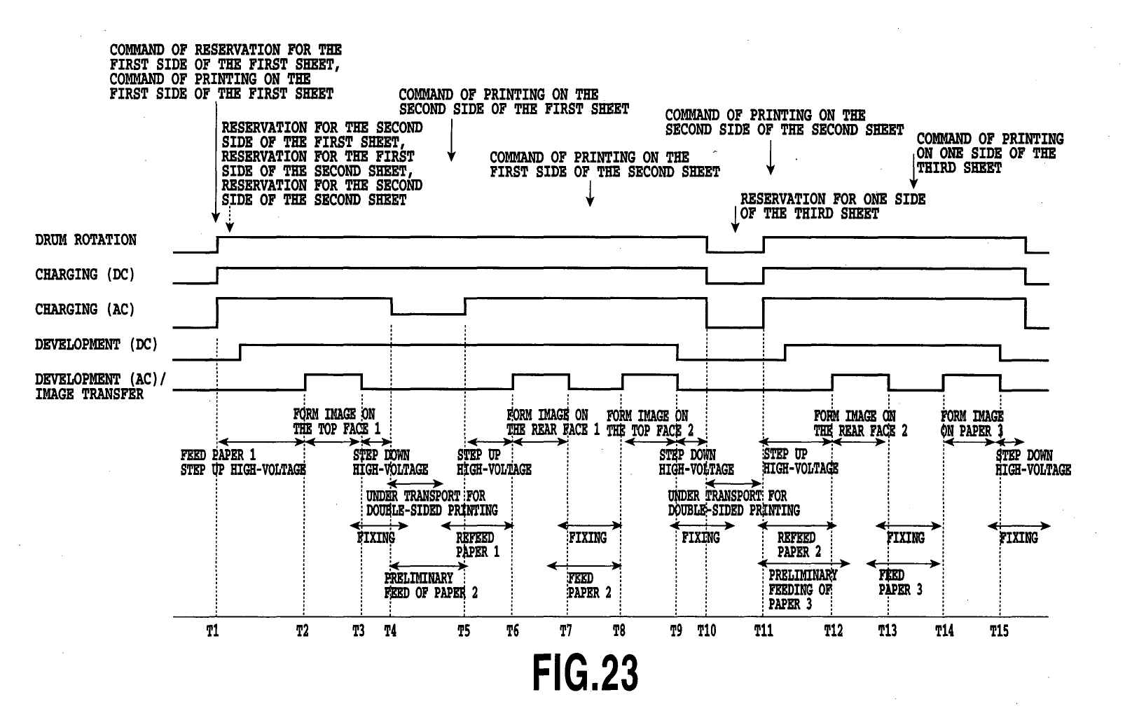

FIGS. 20A-20K are print reservation tables for the image forming apparatus of the fifth embodiment. FIGS. 21-23 are timing charts for printing in the image forming apparatus of the fifth embodiment. FIGS. 20A-20K correspond to FIG. 21, and FIGS. 22A-22M correspond to FIG. 23. With reference to those figures, the print reservation and the sequence of printing in the invention will be described below.

In FIGS. 20A-20K and FIG. 21, it is assumed that twp paper sheets from the top cassette 202 are ejected to the output tray 221 after double-sided printing. Double-sided printing is conducted on each sheet at a time in the order of the first side of the first sheet, second side of the first sheet, first side of the second sheet and second side of the second sheet. The top cassette 202 has at least two A4-size paper sheets. Because FIGS. 17A-17K for the fourth embodiment are very similar to FIG. 18, the differences are described here.

In the print reservation tables, the differences lie only between FIG. 17H for the fourth embodiment and FIG. 20H for the fifth embodiment. Because the feeder roller is not operable, preliminary paper feeding is disabled while high-voltage is stepped down (high-voltages for development and image transfer are terminated and then both dc and AC voltages for charging are terminated) after image formation on the first side is over, the rotation of the photosensitive drum 215 is stopped and the paper is under transport in the turn-over unit (the paper is turned over and transported to the position for re-feeding). Thus in this embodiment, preliminary paper feeding is prohibited during this period of time and preliminary paper feeding is delayed.

In FIG. 20H, while the second sheet is under transport in the turn-over unit for double-sided printing, an error prohibiting preliminary paper feeding is written in the reservation of the subsequent prints. When the second sheet has been transported to the position of re-feeding, the rotation of the photosensitive drum is resumed, and the second paper is re-fed for printing on the second side, then preliminary feeding is permitted. In FIG. 20I, the error prohibiting preliminary feeding of the second sheet is deleted and the status is changed to “under feeding”.

In terms of the time charts for printing, the differences lie only between FIG. 18 for the fourth embodiment and FIG. 21 for the fifth embodiment in the timing of re-feeding of the first sheet for printing on its second side and the timing of stepping up high voltage of restoring charging AC high-voltage Vcac. In the fifth embodiment, the charging AC high-voltage vcac is restored after the time (T5) of step-up of charging AC high-voltage Vcac has passed before starting image formation (T6). As a result, compared with FIG. 18 for the fourth embodiment where the charging AC high-voltage Vcac is restored upon re-feeding, the time of low output of charging AC high-voltage Vcac becomes longer and therefore the wear of the photosensitive drum 215 can be reduced.

In FIGS. 22A-22M and FIG. 23, it is assumed that two paper sheets from the top cassette 202 are ejected to the output tray 221 after double-sided printing and that single-sided printing is conducted on one sheet that is sent from the bottom cassette 205 to the output tray 221 during the transport of the second sheet for printing on its second side (while the rotation of the photosensitive drum 215 is suspended). Double-sided printing is conducted on each sheet at a time in the order of the first side of the first sheet, second side of the first sheet, first side of the second sheet and second side of the second sheet. The top cassette 202 has at least two A4-size paper sheets, and the bottom cassette 205 has at least one A4-size sheet of paper.

Because FIGS. 22A-22H are the same as FIGS. 20A-20H, FIG. 22I and the latter figures are explained here.

Because the feeder roller is not operable, preliminary paper feeding is disabled while high-voltage is stepped down (high-voltages for development and image transfer are terminated and then both dc and AC voltages for charging are terminated) after image formation on the first side is over, the rotation of the photosensitive drum 215 is stopped and the paper is under transport in the turn-over unit (the paper is turned over and transported to the position for re-feeding). Thus in this embodiment, preliminary paper feeding is prohibited during this period of time and preliminary paper feeding is delayed.

In FIG. 22H, while the second sheet is under transport in the turn-over unit for double-sided printing, an error prohibiting preliminary paper feeding is written in the reservation of the subsequent prints. It is assumed that the video controller 242 issues a command of print reservation with a print condition for a side of the third sheet (ID=14, feeder port=bottom cassette, output port=output tray). When the engine controller 243 receives the command of print reservation for a side of the third sheet, it enters the condition in the print reservation table 243g. However, because the printing process is now in the period of prohibiting preliminary paper feeding when the feeder roller cannot be activated, an error prohibiting preliminary feeding is written in the table to prohibit preliminary paper feeding. As shown in FIG. 22I, the printing on one side of the third sheet of ID=14 is listed with the status of “standby for feeding” and “error=prohibiting preliminary paper feeding”.

When the transport of the second sheet for double-sided printing is over, the rotation of the photosensitive drum is resumed, and the second paper is re-fed for printing on the second side, then preliminary feeding is enabled and preliminary feeding of the third sheet is initiated. In FIG. 22J, the error prohibiting preliminary feeding for the second sheet and the third sheet is deleted, and the status of the second sheet and that of the third sheet are changed to “under feeding”. With respect to the first side of the second sheet, since printing on the second side of the second sheet is already started, the status is changed to “second side under processing”.

When the video controller 242 has translated the image data into bit data for printing on the second side of the second sheet, it provides to the engine controller 243 a printing command for the second side of the second sheet. Now that the engine controller 243 has completed paper re-feeding and the video controller 242 has issued a command of printing, image formation is initiated under exchange of vertical synchronization signals (VSREQ signal and VSYNC signal). At the same time, as shown in FIG. 22K, the status of ID=7 for the second side of the second sheet is updated to “under printing”.

When the engine controller 243 has completed image formation on the second side of the second sheet, the toner image is fixed and the sheet is ejected. When it receives the printing command for one side of the third sheet, it completes the paper feeding of the third sheet and starts image formation thereon. As shown in FIG. 22L, when the second sheet is ejected, the status information about the first and second sides of the second sheet is all deleted, and the status of the third sheet is changed to “under printing”. When image formation on the one side of the third sheet is over, high-voltages are stepped down (high-voltages for development and image transfer are terminated and then charging DC high-voltage Vcdc and charging AC high-voltage Vcac are terminated), and the rotation of the photosensitive drum 215 is stopped. The scanner motor is also deactivated.

As shown in FIG. 22M, when the third sheet is ejected, the information about ID=14 for one side of the third sheet is deleted and no more reservation is left. In the time charts of printing, the only difference between FIG. 21 and FIG. 23 is that the step for one side of the third sheet is added in FIG. 23. As indicated by an arrow in FIG. 23, printing for one side of the third sheet is reserved by reservation memory 243g under command from printing command unut 242f of video controller 242 while the photosensitive drum is deactivated during paper transport for double-sided printing (T10-T11). Because the photosensitive drum 215 is deactivated and the feeder roller cannot be rotated (T10-T11), preliminary paper feeding is not started. Instead, preliminary paper feeding is started when the rotation of the photosensitive drum 215 is resumed and the feeder roller becomes operable.

Then a paper jam is avoided by preventing preliminary paper feeding while the feeder roller is deactivated. As soon as the feeder roller becomes operable, preliminary paper feeding is started to minimize the decrease in throughput.

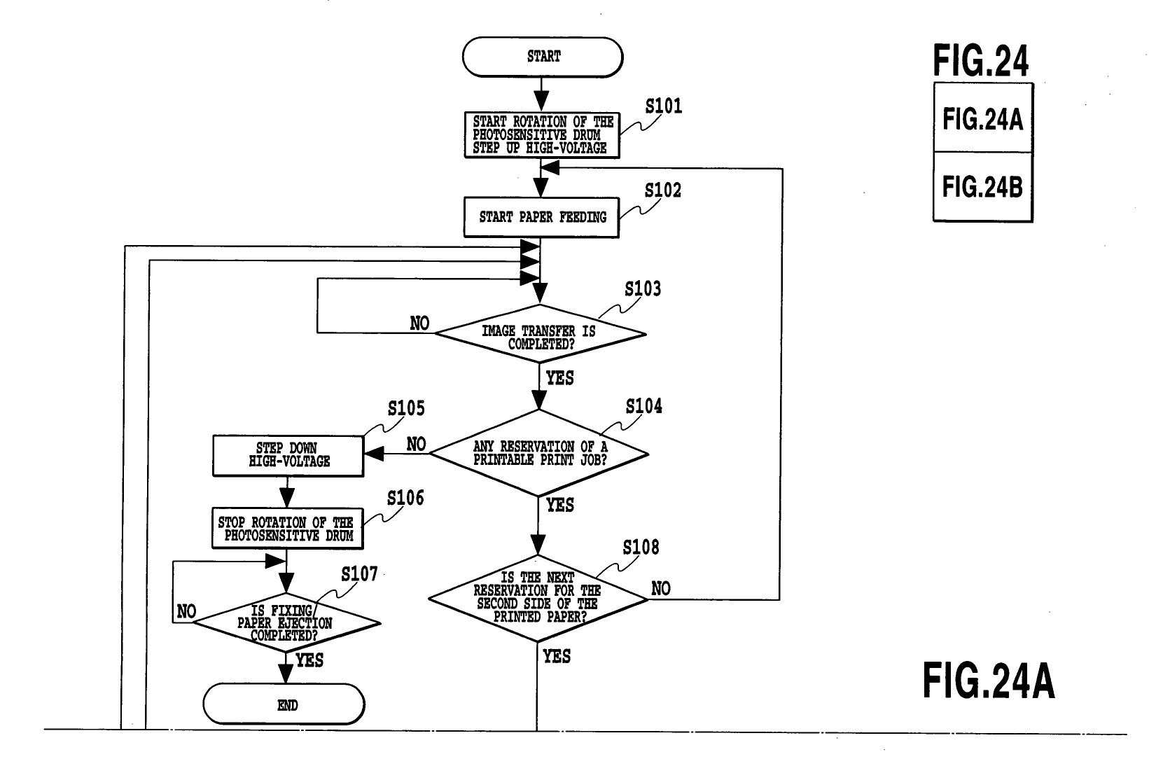

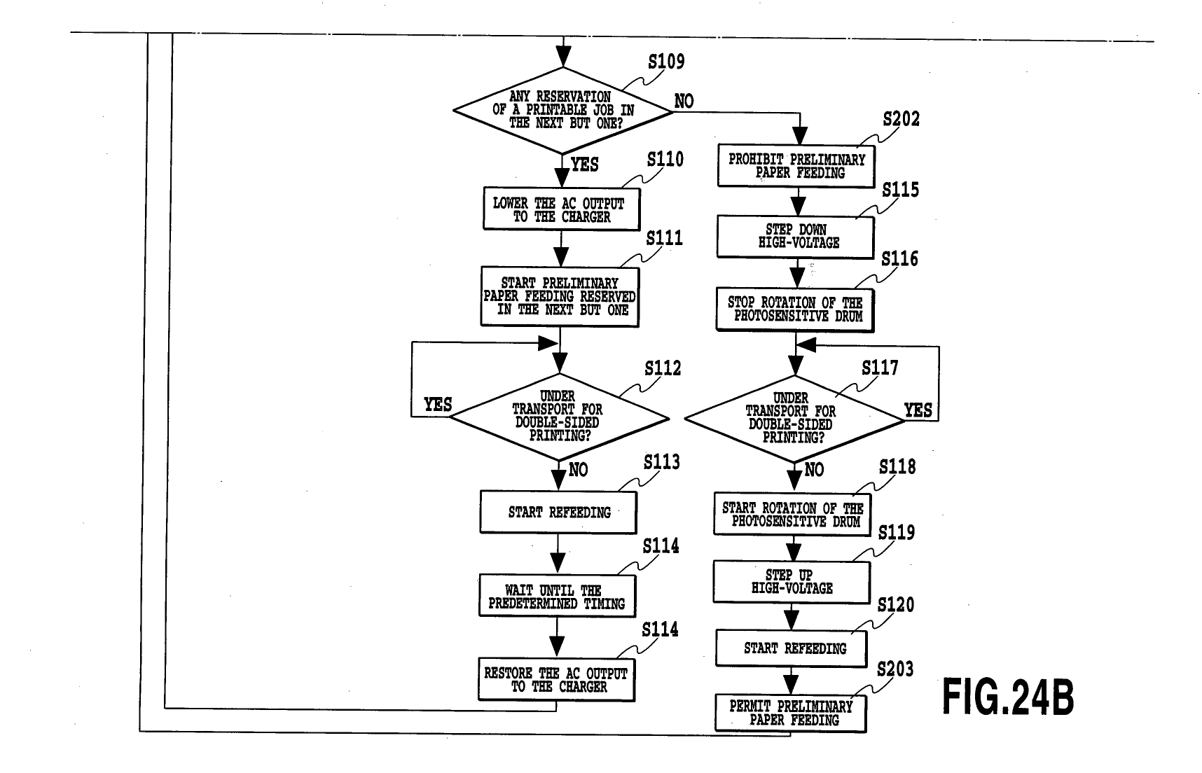

FIGS. 24A and 24B are a flowchart illustrating the steps of printing in the engine controller in the image forming apparatus of the fifth embodiment. The figure focuses on paper feeding and image formation in the printing operation. The same numbers are given to the similar steps in FIGS. 24A-24B and FIGS. 19A-19B for the fourth embodiment, and their explanation is not repeated. The differences between FIGS. 19A-19B and FIGS. 24A-24B are three steps S201, S202 and S203. First, step S201 is explained.

When transport in the turn-over mechanism is ended (step S112), the sheet that has been transported to the position of re-feeding is re-fed for printing on its second side (step S113). In a predetermined time (step S201), the charging AC high-voltage Vcac is restored (step S114). An image is formed on the second side, and the process returns to step S103. Compared with the first embodiment, the time of low output leading to less wear of the photosensitive drum 215 is extended in this embodiment by restoring the output of charging AC high-voltage Vcac after a certain period of time. If this period of time is set to the time for step-up of the charging AC high-voltage Vcac, the wear of the photosensitive drum 215 is prevented effectively.

Next described are steps S202, S203. Unless a printable print job is reserved in the next but one at step S109, preliminary paper feeding is prohibited (step S202), high-voltages are stepped down (high-voltages for development and image transfer are terminated and then both charging DC high-voltage Vcdc and charging AC high-voltage Vcac are terminated) (step S115), and the rotation of the photosensitive drum 215 is stopped (step S116). Then the first side image of the sheet is fixed, and the sheet is turned over and transported to the position for double-sided printing (step S117). When such paper transport is completed, the rotation of the photosensitive drum 215 is resumed (step S118), and high-voltages are stepped up (both charging AC high-voltage Vcac and charging DC high-voltage Vcdc are provided and then the DC high-voltage Vdc for development is provided) (step S119). The sheet transported to the position for re-feeding is now re-fed for printing on the second side (step S120), and preliminary paper feeding is permitted (step S203). An image is formed on the second side, and the process returns to step S103.

In this manner, preliminary paper feeding is prohibited during the time while the rotation of the photosensitive drum 215 is stopped and therefore the feeder roller is not operable, while preliminary paper feeding is permitted when the rotation of the photosensitive drum 215 is resumed. Then it becomes possible to prevent detecting a paper jam error when preliminary paper feeding is initiated during the time while it is prohibited.

As described so far, in the fifth embodiment compared with the fourth embodiment, the wear of the drum is prevented by extending the period of time of terminating the output of charging AC high-voltage Vcac. Furthermore, to prevent photosensitive drum 215 wear, preliminary paper feeding is prohibited while the rotation of the photosensitive drum 215 is stopped. If a print reservation is received during such period, preliminary paper feeding is suspended until the rotation of the photosensitive drum 215 is resumed. Then it becomes possible to prevent photosensitive drum 215 wear without error detection of a paper jam while maximizing throughput.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. An image forming apparatus that forms an electrostatic latent image on an image carrier, comprising:
a charging unit for charging the image carrier;
a charge voltage loading unit for applying charge voltage to the charging unit;
an exposure unit for exposing the image carrier charged by the charging unit to form an electrostatic latent image corresponding to image signals;
a development unit for forming a toner image by developing the electrostatic latent image formed on the image carrier by the image carrier;
an image transfer unit for continuously transferring the toner image formed by the development unit onto a plurality of recording materials; and
a control unit for controlling ac charge voltage applied by the charge voltage loading unit to the charging unit,
wherein, when the transport interval of the plural recording materials is shorter than a predetermined time the AC charge voltage applied to the image carrier during the transport interval being a first AC charge voltage, and when the transport interval is longer than the predetermined time the ac charge voltage applied to the image carrier during the transport interval being a second AC charge voltage,
the control unit makes the current running in the charging unit to which the second charge voltage is applied lower than the current running in the charging unit to which the first AC charge voltage is applied.

2. The image forming apparatus according to claim 1, further comprising a current detection unit for detecting current running in the charging unit, wherein the control unit controls the AC charge voltage applied by the charge loading unit so that the current detected by said current detection unit is equal to a predetermined current value.

3. The image forming apparatus according to claim 2, wherein the first AC charge voltage is such a voltage that the charge voltage loading unit applies so that the predetermined current value becomes equal to a first predetermined current value, while the second AC charge voltage is such a voltage that the charge voltage loading unit applies so that the predetermined current value becomes equal to a second predetermined current value that is lower than the first predetermined current value.

4. The image forming apparatus according to claim 3, wherein said predetermined time is the sum of the time for the first predetermined current value to step down to the second predetermined current value and the time for the second predetermined current value to step up to the first predetermined current value.

5. The image forming apparatus according to claim 1, wherein the charge voltage loading unit applies a charge voltage where a DC charge voltage is added to the AC charge voltage so that the image carrier is charged to a predetermined potential.

6. The image forming apparatus according to claim 5, wherein the development unit applies a predetermined voltage to the non-image formation area of the image carrier.

7. The image forming apparatus according to claim 6, wherein the control unit controls the second ac charge voltage so that the predetermined potential becomes higher than the predetermined voltage.

8. An image forming apparatus that forms an electrostatic latent image on an image carrier, comprising:
a charging unit for charging the image carrier;
a charge voltage loading unit for applying charge voltage to the charging unit;
an exposure unit for exposing the image carrier charged by the charging unit and forms an electrostatic latent image corresponding to image signals;
a development unit for forming a toner image by developing the electrostatic latent image formed on the image carrier by the image carrier;
an image transfer unit for continuously transferring the toner image formed by the development unit onto a plurality of recording materials;
a fixer unit for fixing the toner image transferred by the image transfer unit to the recording material;
a transport unit for transporting the recording material to the image transfer unit to transfer a toner image onto the other side of the recording material where a toner image has been fixed by the fixer unit; and
a control unit for controlling ac charge voltage applied by the charge voltage loading unit to the charging unit,
wherein, while the transport unit is not transporting the recording material the AC charge voltage being a first AC charge voltage, and while the transport unit is transporting the recording material the AC charge voltage being a second AC charge voltage,
the control unit makes the current running in the charging unit to which the second charge voltage is applied lower than the current running in the charging unit to which the first AC charge voltage is applied.

9. The image forming apparatus according to claim 8, further comprising a current detection unit for detecting current running in the charging unit, wherein the control unit controls the AC charge voltage applied by the charge loading unit so that the current detected by said current detection unit is equal to a predetermined current value.

10. The image forming apparatus according to claim 9, wherein the first AC charge voltage is such a voltage that the charge voltage loading unit applies so that the predetermined current value becomes equal to a first predetermined current value, while the second AC charge voltage is such a voltage that the charge voltage loading unit applies so that the predetermined current value becomes equal to a second predetermined current value that is lower than the first predetermined current value.

11. The image forming apparatus according to claim 8, wherein the charge voltage loading unit applies a charge voltage where a DC charge voltage is added to the AC charge voltage so that the image carrier is charged to a predetermined potential.

12. The image forming apparatus according to claim 11, wherein the development unit applies a predetermined voltage to the non-image formation area of the image carrier.

13. The image forming apparatus according to claim 12, wherein the control unit controls the second AC charge voltage so that the predetermined potential becomes higher than the predetermined voltage.

14. An image forming apparatus that forms an electrostatic latent image on an image carrier, comprising:
a charging unit for charging the image carrier;
a charge voltage loading unit for applying charge voltage to the charging unit;
an exposure unit for exposing the image carrier charged by the charging unit and forms an electrostatic latent image corresponding to image signals;
a development unit for forming a toner image by developing the electrostatic latent image formed on the image carrier by the image carrier;
an image transfer unit for continuously transferring the toner image formed by the development unit onto a plurality of recording materials;
a fixer unit for fixing the toner image transferred by the image transfer unit to the recording material;
a feeder unit for feeding the recording material from a recording material container where a plurality of recording materials are loaded;
a transport unit for transporting the recording material to the image transfer unit to transfer a toner image onto the other side of the recording material where a toner image has been fixed by the fixer unit;
a control unit for controlling ac charge voltage applied by the charge voltage loading unit to the charging unit; and
a memory unit for storing the image formation conditions about the plural recording materials based on the command sent from an external device,
wherein, while the transport unit is not transporting the recording material, the AC charge voltage being a first AC charge voltage, and
while the transport unit is transporting the recording material and the feeder unit is feeding the recording material subsequent to said recording material based on the image formation conditions stored in the memory unit, the AC charge voltage being a second AC charge voltage,
the control unit makes the current running in the charging unit to which the second charge voltage is applied lower than the current running in the charging unit to which the first AC charge voltage is applied.

15. The image forming apparatus according to claim 14, wherein the control unit does not apply the AC charge voltage when the transport unit is transporting the recording material and the memory unit does not have any image formation conditions about the recording material subsequent to said recording material.

16. The image forming apparatus according to claim 15, further comprising a driver unit for driving the image carrier and the feeder unit so that paper feeding by the feeder unit proceeds concurrently with the rotation of the image carrier.

17. The image forming apparatus according to claim 16, wherein the driver unit does not rotate the image carrier when the transport unit is transporting the recording material and the memory unit does not have any image formation conditions about the recording material subsequent to said recording material.

18. The image forming apparatus according to claim 14, further comprising a current detection unit for detecting current running in the charging unit, wherein the control unit controls the AC charge voltage applied by the charge voltage loading unit so that the current detected by said current detection unit is equal to a predetermined current value.

19. The image forming apparatus according to claim 18, wherein the first AC charge voltage is such a voltage that the charge voltage loading unit applies so that the predetermined current value becomes equal to a first predetermined current value, while the second AC charge voltage is such a voltage that the charge voltage loading unit applies so that the predetermined current value becomes equal to a second predetermined current value that is lower than the first predetermined current value.

20. The image forming apparatus according to claim 14, wherein the charge voltage loading unit applies a charge voltage where a DC charge voltage is added to the AC charge voltage so that the image carrier is charged to a predetermined potential.

21. The image forming apparatus according to claim 20, wherein the development unit applies a predetermined voltage to the non-image formation area of the image carrier.

22. The image forming apparatus according to claim 21, wherein the control unit controls the second AC charge voltage so that the predetermined potential becomes higher than the predetermined voltage.
